(19) United States
(12) Patent Application Publication
(10) Pub. No.: US 2026/0111233 A1
(43) Pub. Date: Apr. 23, 2026

(54) TECHNIQUES FOR CONFIGURABLE INTELLIGENT COMPUTING FABRIC

(71) Applicant: US AI, North Bethesda, MD (US)

(72) Inventor: David Thang NGUYEN, North Bethesda, MD (US)

(21) Appl. No.: 19/364,954

(22) Filed: Oct. 21, 2025

Related U.S. Application Data
(60) Provisional application No. 63/709,626, filed on Oct. 21, 2024.

(51) Int. Cl. G06F 9/38

(52) U.S. Cl. CPC G06F 9/3826; G06F 9/3836

(57) ABSTRACT

Example implementations include a method, apparatus and computer-readable medium of constructing a multi-generative model pipeline, comprising providing a plurality of generative models including a first generative model and a second generative model different from the first generative model, wherein the first generative model is associated with first output data and the second generative model is associated with second output data different from the first output data. The implementations further include receiving a selection of the first generative model. Additionally, the implementations further include inserting the first generative model into the multi-generative model pipeline representing a data processing environment. Additionally, the implementations further include receiving a selection of the second generative model. Additionally, the implementations further include inserting the second generative model into the multi-generative model pipeline, and providing pipeline output data based on the first output data and the second output data.

### CROSS-REFERENCE TO RELATED APPLICATION(S)

This application claims the benefit of U.S. Provisional Patent Application No. 63/709,626, entitled “TECHNIQUES FOR CONFIGURABLE INTELLIGENT COMPUTING FABRIC” and filed on Oct. 21, 2024, which is expressly incorporated by reference herein in its entirety.

### TECHNICAL FIELD

The described aspects relate to generative artificial intelligence, and more specifically to techniques for configurable intelligence compute fabric in a generative computing environment.

### INTRODUCTION

Generative Artificial Intelligence (AI) has revolutionized software engineering, enabling new possibilities in automation, content creation, and problem-solving. However, despite its transformative potential, generative AI also comes with significant limitations and challenges, particularly when viewed through a software engineering lens. One major issue is the inherent unpredictability and lack of precision in AI-generated outputs. AI models, such as large language models (LLMs), are often probabilistic in nature, meaning they generate results based on patterns in the data they've been trained on rather than strict rules. This can lead to outputs that are incorrect, irrelevant, or even harmful, which is especially problematic in environments that require high levels of accuracy and reliability, such as in coding or decision-making.

Another limitation is the challenge of interpretability and explainability. Many generative AI models, especially deep learning models, operate as “black boxes,” making it difficult for engineers to understand how and why the AI arrived at a specific solution. In software engineering, where understanding the logic and flow of code is crucial, this lack of transparency can create significant hurdles. Engineers may struggle to debug or modify AI-generated code because the AI's decision-making process is often opaque, leading to inefficiencies and potential risks. Moreover, this raises concerns in highly regulated industries, such as finance or healthcare, where explainability and accountability are essential for compliance and safety.

Data dependency is another key issue. Generative AI models require vast amounts of high-quality training data to function effectively, but acquiring such data can be costly and time-consuming. Furthermore, if the training data is biased, outdated, or incomplete, the AI model will inherit and reflect these shortcomings in its outputs. In software development, this can lead to biased code, unfair algorithms, or systems that fail to generalize well to new inputs. Engineers must also consider the computational resources needed to train and run these models, which can be prohibitively expensive, especially for smaller companies. High computational costs can also lead to inefficiencies in real-time applications, where quick responses are necessary but difficult to achieve with large generative models.

It is with respect to these and other considerations that examples have been made. In addition, although relatively specific problems have been discussed, it should be understood that the examples should not be limited to solving the specific problems identified in the background.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of constructing a multi-generative model pipeline, comprising providing a plurality of generative models including a first generative model and a second generative model different from the first generative model, wherein the first generative model is associated with first output data and the second generative model is associated with second output data different from the first output data. The method further includes receiving a selection of the first generative model. Additionally, the method further includes inserting the first generative model into the multi-generative model pipeline representing a data processing environment. Additionally, the method further includes receiving a selection of the second generative model. Additionally, the method further includes inserting the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline. Additionally, the method further includes providing pipeline output data based on the first output data of the first generative model and the second output data of the second generative model.

Another example aspect includes an apparatus for constructing a multi-generative model pipeline, comprising one or more memories and one or more processors coupled with one or more memories and configured to perform, individually or in any combination, the follow actions. The one or more processors are configured to provide a plurality of generative models including a first generative model and a second generative model different from the first generative model, wherein the first generative model is associated with first output data and the second generative model is associated with second output data different from the first output data. The one or more processors are further configured to receive a selection of the first generative model. Additionally, the one or more processors are further configured to insert the first generative model into the multi-generative model pipeline representing a data processing environment. Additionally, the one or more processors are further configured to receive a selection of the second generative model. Additionally, the one or more processors are further configured to insert the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline. Additionally, the one or more processors are further configured to provide pipeline output data based on the first output data of the first generative model and the second output data of the second generative model.

Another example aspect includes an apparatus for constructing a multi-generative model pipeline, comprising means for providing a plurality of generative models including a first generative model and a second generative model different from the first generative model, wherein the first generative model is associated with first output data and the second generative model is associated with second output data different from the first output data. The apparatus further includes means for receiving a selection of the first generative model. Additionally, the apparatus further includes means for inserting the first generative model into the multi-generative model pipeline representing a data processing environment. Additionally, the apparatus further includes means for receiving a selection of the second generative model. Additionally, the apparatus further includes means for inserting the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline. Additionally, the apparatus further includes means for providing pipeline output data based on the first output data of the first generative model and the second output data of the second generative model.

Another example aspect includes a computer-readable medium having instructions stored thereon for constructing a multi-generative model pipeline, wherein the instructions are executable by one or more processors, individually or in combination, to perform the following actions. The instructions are executable to provide a plurality of generative models including a first generative model and a second generative model different from the first generative model, wherein the first generative model is associated with first output data and the second generative model is associated with second output data different from the first output data. The instructions are further executable to receive a selection of the first generative model. Additionally, the instructions are further executable to insert the first generative model into the multi-generative model pipeline representing a data processing environment. Additionally, the instructions are further executable to receive a selection of the second generative model. Additionally, the instructions are further executable to insert the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline. Additionally, the instructions are further executable to provide pipeline output data based on the first output data of the first generative model and the second output data of the second generative model.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a block diagram of an example of a system having components configured to perform a method of constructing a multi-generative model pipeline, in accordance with various implementations of the present disclosure;

FIG. 2 is a block diagram of an example of an application, data, cloud planes for developing generative artificial intelligence (AI), in accordance with various implementations of the present disclosure;

FIG. 3 is a diagram of an example of a comparison of outputs of different models, in accordance with various implementations of the present disclosure;

FIG. 4 is a block diagram of an example of a relationship be a master tenant and dedicated tenants in the cloud plane, in accordance with various implementations of the present disclosure;

FIG. 5 is a diagram of an example interface for integrations of a plurality of generative AI models or systems, in accordance with various implementations of the present disclosure;

FIG. 6 is a diagram of an example interface for configurable application programming interface (API), in accordance with various implementations of the present disclosure;

FIG. 7 is a diagram of an example interface for workspaces, in accordance with various implementations of the present disclosure;

FIGS. 8A-8F are diagrams of an example process for a global integration factory, in accordance with various implementations of the present disclosure;

FIGS. 9A-9K are diagrams of an example process for building and chaining generative and classical AI models, in accordance with various implementations of the present disclosure;

FIG. 10 is a block diagram of an example codeless workflow for linking processes or steps together, in accordance with various implementations of the present disclosure;

FIGS. 11A-11D are diagrams of an example process for management of data lineages, in accordance with various implementations of the present disclosure;

FIG. 12 is a block diagram of an example vertical database for dynamic data transformation, in accordance with various implementations of the present disclosure;

FIG. 13 is a block diagram of an example of configurable data pipelines and native integration with cloud infrastructure, in accordance with various implementations of the present disclosure;

FIG. 14 is a flowchart of an example configurable data pipelines and native integration with cloud infrastructure, in accordance with various implementations of the present disclosure;

FIG. 15 is a diagram of an interface for vulnerability analysis of a data pipeline, in accordance with various implementations of the present disclosure;

FIG. 16 is a diagram of an interface for configuring graphics processing unit (GPU) clusters or pods, in accordance with various implementations of the present disclosure;

FIG. 17 is a flowchart of an example of a method of automating enterprise cloud tenancy setup, in accordance with various implementations of the present disclosure;

FIG. 18 is a flowchart of an example of a method of constructing a multi-generative model pipeline;

FIGS. 19-23 are flowcharts of additional aspects of the method of FIG. 18, in accordance with various implementations of the present disclosure; and

FIG. 24 is a block diagram illustrating example physical components of a computing device with which aspects of the disclosure may be practiced.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to an intelligent computing fabric, and more specifically to techniques for optimizing user experience, data pipelines, and cloud resources associated with generative artificial intelligence (AI) systems. Generative AI has transformed the way data may be accessed, processed, and presented to a user. Users now can leverage vast amounts of data for nearly any purpose using cloud computing power. For example, some generative AI system can output text, images or code based on inputs corresponding to text based prompts provided by users. The architecture of such generative AI systems may rely on machine learning and be based on one or more of transformers, generative adversarial networks (GAN), or variational autoencoders (VAE). However, current generative AI systems may provide a singular or narrow function such as text output to text prompt or image output to text prompt. In other words, the static nature of current generative AI systems may not support building generative AI models, training models on selectable datasets, constructing multi-generative model pipelines including a plurality of generative AI models linked together to output data fed through the plurality of generative AI models, and generative model integrations.

The present implementations set forth constructing complex training models by spinning up and down clusters and pods on demand to optimize cost; publish end points inject intelligence into applications; and to run inferences at speed and scale across an elastically scalable cloud platform. In an implementation, a multi-generative model pipeline may be constructed to comprise a number of linked generative AI models each having a specific function. In another implementation, generative AI model integrations may be generated to provide wider integration to other software systems and services. In a further implementation, the acquisition and transformation of data can be configured and identified using data lineage techniques.

Particular implementations of the subject matter described in this disclosure can be implemented to realize one or more of the following potential advantages. The disclosed techniques can allow multiple generative AI models to effectively work together in a multi-nodal structure where output data from one generative AI model associated with a particular function, i.e., language translation, is fed into another generative AI model having a different function, i.e., security risk analyzer. Further, the present implementations support building generative AI models, integrations, and pipelines to provide the advantage of multiple generative AI models working together. As such, the techniques described herein may provide a configurable generative AI compute platform for building and configuring generative AI models, chaining generative AI models into a harmonious workflows, and managing cloud compute.

As such, the implementations set forth herein relate to systems and methods for constructing a multi-generative model pipeline. The systems and methods may include providing a plurality of generative models including a first generative AI model and a second generative AI model different from the first generative model. The first generative AI model may be associated with first output data and the second generative AI model may be associated with second output data different from the first output data. The systems and methods may further include receiving a selection of the first generative model. The systems and methods may further include inserting the first generative model into the multi-generative model pipeline representing a data processing environment. The systems and methods may further include inserting the first generative model into the multi-generative model pipeline representing a data processing environment and receiving a selection of the second generative model. The systems and methods may further include inserting the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline. The systems and methods may further include providing pipeline output data based on the first output data of the first generative model and the second output data of the second generative model

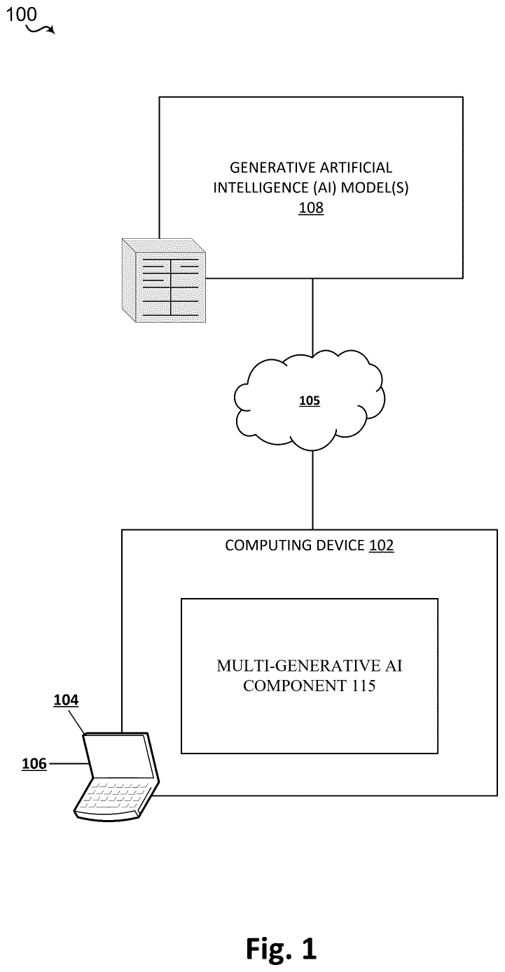

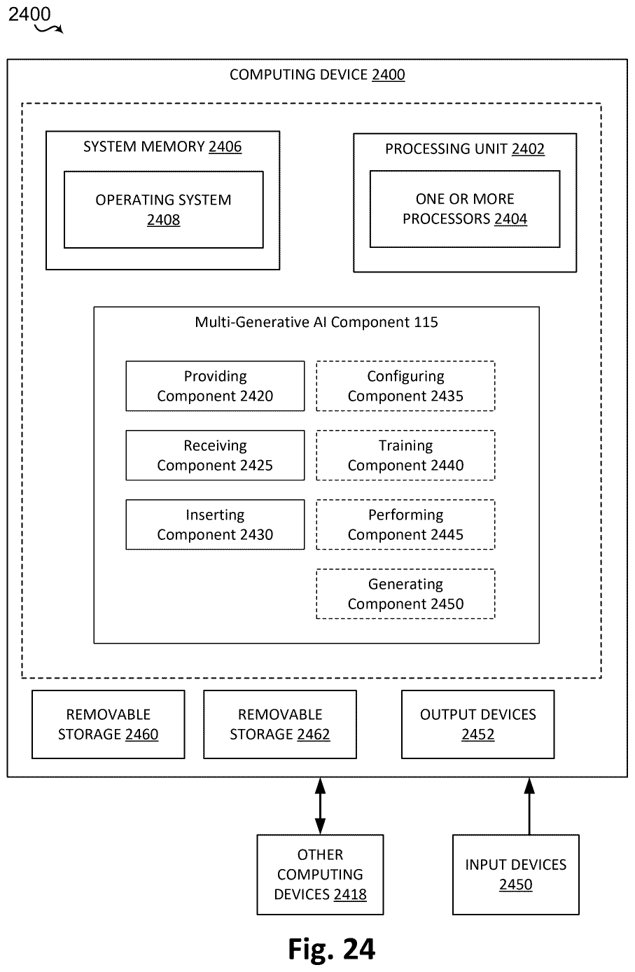

FIG. 1 is an example of a block diagram of a system 100 for constructing a multi-generative model pipeline in accordance with an example implementation. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 24. In another example, the components of systems disclosed herein are distributed across multiple processing devices. For instance, input may be entered on a user device or client device and information may be processed on or accessed from other devices in a network, such as one or more remote cloud devices or web server devices.

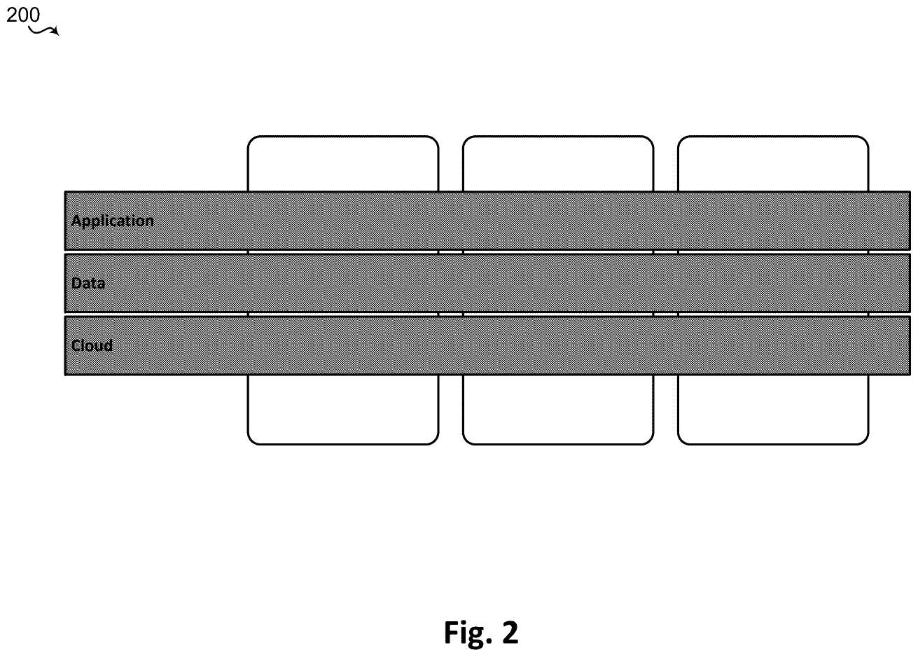

In examples, the computing device 102 includes a plurality of productivity applications (collectively, productivity applications) for performing different tasks, such as communicating, information generation and/or management, data manipulation, visual construction, resource coordination, calculations, etc. According to an example implementation, the productivity applications include multi-generative AI component 115, which may be configured to build and configure generative AI models, chain generative AI models into a harmonious workflows, and manage cloud compute. The multi-generative AI component 115 may comprise local applications or web-based applications accessed via a web browser. The multi-generative AI component 115 may have one or more application UIs 106 by which a user can view and interact with features provided by the multi-generative AI component 115. For example, an application UI 106 may be presented on the display screen 104. These and other examples are described below in further detail with reference to FIGS. 2-24.

According to example implementations, the generative Al models 108 are generative machine learning models trained to understand and generate sequences of tokens, which may be in the form of natural language (e.g., human-like text). In various examples, the generative Al model 108 can understand complex intent, cause and effect, perform language translation, semantic search classification, complex classification, text sentiment, summarization, summarization for an audience, and/or other natural language capabilities.

Referring to FIG. 2, an example of a block diagram 200 of an application, data, cloud planes for developing generative artificial intelligence (AI) in accordance with an example implementation is provided. Conventionally, the application plane, data plane, and cloud plane were each managed independently, with no integrated orchestration between them. This siloed approach limited the potential to fully leverage emerging technologies, including AI. The present invention addresses this shortcoming by providing a system and method for integrating the application, data, and cloud planes into an intelligent computing fabric that orchestrates and optimizes user experiences, data pipelines, and cloud resources.

In an aspect, the intelligent computing fabric allows for a high degree of configurability by users, including non-technical personnel. The fabric enables users to build and configure AI models, chain said models into cohesive workflows, manage cloud compute resources, and execute AI processes continuously, 24 hours a day, 7 days a week, with a guaranteed uptime of 99.9999%. The system further allows for seamless orchestration of AI-driven tasks while minimizing the need for specialized technical knowledge, thus optimizing operational efficiency and resource allocation across the integrated planes.

The multi-generative model pipeline improves upon the existing state of the art by offering a scalable and adaptable framework for leveraging the full capabilities of AI within a unified computing environment, significantly enhancing operational reliability, accessibility, and configurability.

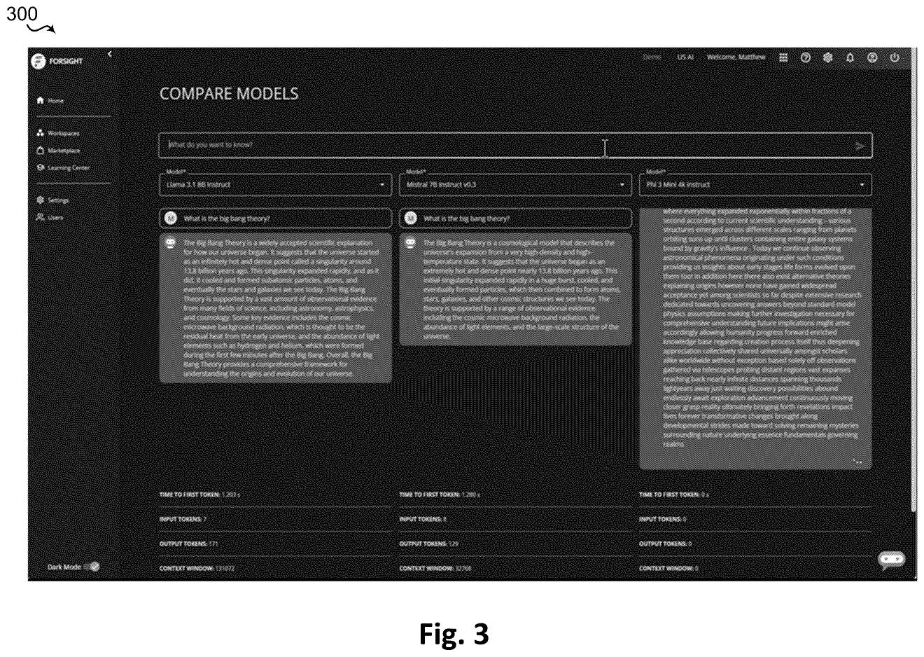

Referring to FIG. 3, a diagram 300 of a comparison of outputs of different models in accordance with an example implementation is provided. For example, diagram 300 illustrates an example interface for establishing a private, dedicated tenant in any cloud environment, enabling them to host a variety of AI models, extend said models with business-specific data, and make these models available throughout the organization. In this example of interface 300, outputs of the same prompt from three different LLM are compared along with efficiency data for each of the three different LLM, such as time to first token, number of input tokens and output tokens, and context window.

For instance, in one implementation, a healthcare company may leverage an open-source AI model and train it using proprietary healthcare data, all while ensuring compliance with the Health Insurance Portability and Accountability Act (HIPAA). Once trained, the newly enhanced model may be made accessible to all authorized users within the healthcare organization. This provides businesses with a streamlined platform to solve domain-specific problems using a variety of open-source models, optimized for their unique data and requirements.

In an aspect, this computing fabric allows for the building of complex training models by dynamically provisioning and de-provisioning clusters and pods on demand, thereby optimizing costs. Furthermore, the multi-generative model pipeline provides a mechanism to publish endpoints for injecting AI intelligence into applications and executing AI inferences at speed and scale across an elastically scalable cloud platform.

In a further aspect corresponding to the various interfaces in FIG. 3, the system may provide a comparative model evaluation view that concurrently displays responses to a common prompt from multiple large language models (LLMs) alongside operational telemetry for each model. The telemetry can include, without limitation, time-to-first-token, input token count, output token count, and model-specific context window size. The comparative view allows a user to assess responsiveness and output efficiency across models in real time and to select one or more models for inclusion in a pipeline based on objective and subjective performance characteristics.

In another aspect, the comparative evaluation view may be configurable to persist model responses and associated metrics for later review, enabling longitudinal comparison of models across prompt sets. The system can tag each response with a model identifier, version, temperature, top-k, and other inference parameters so that evaluations are reproducible. Stored comparisons can be exported or shared within a workspace to support collaborative model selection decisions.

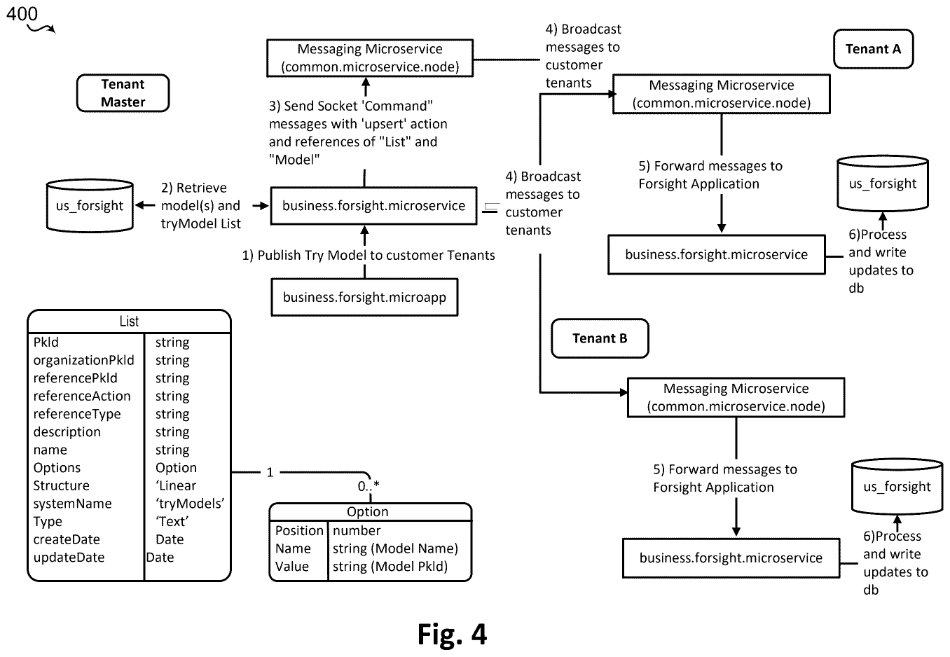

Referring to FIG. 4, a block diagram 400 of an example of a relationship be a master tenant and dedicated tenants in the cloud plane in accordance with an example implementation is provided. For example, block diagram 400 illustrates a microservices-based architecture wherein each microservice operates autonomously and maintains its own independent data store, thereby promoting scalability and modularity within the system. Specifically, the architecture comprises a plurality of microservices, each of which is encapsulated within a discrete functional domain and communicates with its associated database, forming a decentralized data management system.

In an aspect, the system further includes a messaging microservice that facilitates communication between the microservices. Said messaging microservice is responsible for handling asynchronous, event-driven communications between the individual microservices and the other system components, including external systems or APIs. This decoupled communication framework allows for the real-time transmission of data and events between services without the need for direct interaction, thereby improving system resilience and scalability.

In conjunction with the microservices, the block diagram 400 further includes a Business Intelligence Framework integrated within each functional domain. This framework aggregates and processes data received from the microservices' respective databases, enabling the generation of reports, insights, and data-driven decisions. The Business Intelligence Framework interacts with the messaging microservice to retrieve data and events, which are then processed and analyzed.

Additionally, the system architecture is designed to support multi-tenant or distributed deployments, wherein multiple clusters of microservices, each containing a dedicated messaging microservice and business intelligence component, may be deployed across separate domains or environments. These clusters operate independently while maintaining communication via the messaging microservice.

The block diagram 400 provides a scalable, event-driven microservices architecture with decentralized data management, enabling autonomous operation of each microservice, while also incorporating a Business Intelligence Framework to process and analyze data efficiently across the system. This structure improves upon existing systems by reducing dependencies between services, increasing uptime and reliability, and enhancing the ability to scale as the system grows in complexity.

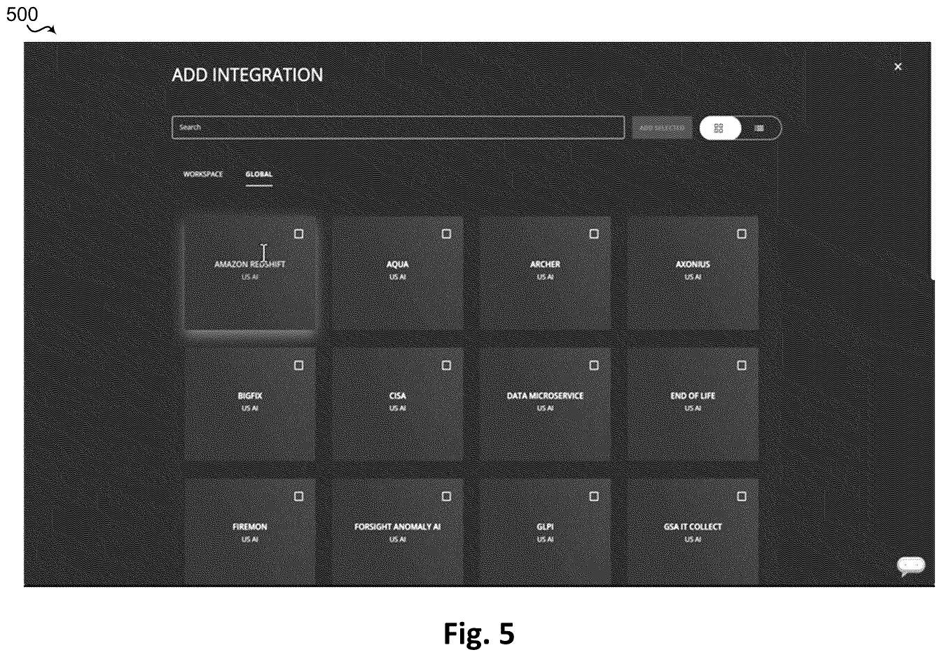

Referring to FIG. 5, a diagram 500 of an example interface for integrations of a plurality of generative AI models or systems in accordance with an example implementation is provided. For example, diagram 500 illustrates codeless integrations with popular cyber platforms. In this context, integration corresponds to the process of connecting and coordinating different software systems and data sources to facilitate data exchange and functionality sharing without the need for extensive manual coding. Such integrations are critical to enabling AI systems to access and process real-time data, making them indispensable for organizations aiming to optimize decision-making, operational efficiency, and the scalability of their AI-powered solutions.

In an aspect, the multi-generative model pipeline introduces a library of pre-built integrations, accessible via a global integration marketplace. This marketplace allows users to browse available integrations, clone them for their specific needs, and configure security parameters according to organizational requirements. Through the global integration marketplace, customers can seamlessly connect their AI systems with external platforms, pull or push data from and to various data sources, transform the data to suit their specific use cases, and publish the curated data into any application within their infrastructure. Importantly, this process is executed in a codeless manner, allowing users, regardless of technical expertise, to perform integrations without writing custom code.

Further, in some implementations, the integration configuration interface supports definition of application programming interfaces (APIs) with explicit control over request method, route, headers, authentication, query parameters, request body, pagination, sorting, filtering, and rate limiting. In one implementation, the interface permits declarative specification of filters (e.g., firstSeen, lastSeen), time windows, source types (e.g., “cumulative”), and sort directives (e.g., sortField and sortDir), as well as offset and limit parameters (e.g., startOffset and endOffset) to page through large result sets.

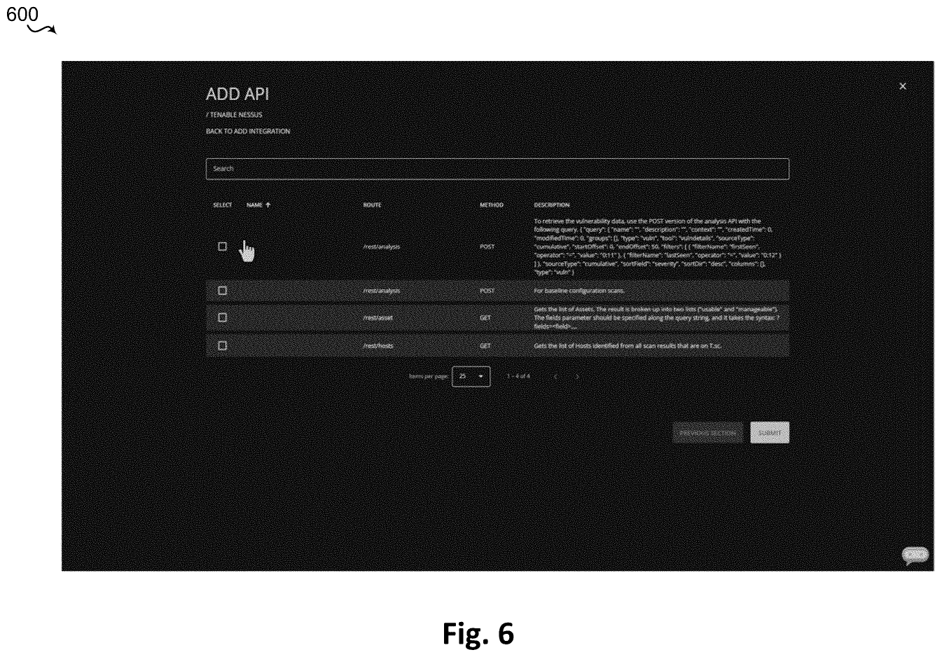

Referring to FIG. 6, a diagram 600 of an example interface for configurable application programming interface (API) in accordance with an example implementation is provided. For example, diagram 600 illustrates incorporating APIs into the integration framework described herein. APIs, in this context, refer to standardized protocols and tools that enable different software applications to communicate and exchange data. The multi-generative model pipeline allows for the seamless addition of APIs to enhance the functionality and flexibility of integrations, thereby enabling real-time data exchange and interaction between external systems and the user's application environment.

In one implementation, the system includes a feature whereby customers may select and integrate third-party APIs into the existing integration structure without the need for manual coding or development. Upon selection, the system automatically configures the API, establishes communication with the external platform, and facilitates the flow of data between the user's application and the external API in a secure and efficient manner. Users may configure the API's parameters, including authentication, data handling, and security protocols, through a user-friendly interface that requires no programming expertise.

Furthermore, the system provides a method for real-time monitoring and management of the APIs added to an integration. The system continuously monitors the performance, availability, and security of the connected APIs and provides alerts or notifications in the event of any issues or interruptions. The data exchange facilitated by the API can be tailored to the user's specific business requirements by leveraging the data transformation tools embedded within the system, ensuring that incoming and outgoing data is structured and formatted to meet the necessary standards for downstream applications.

In some implementations, the system may provide a schema-aware mapping layer that validates the configured API payloads against expected formats and automatically generates parameterized requests. The interface allows users to preview responses, select columns or fields to retain, and define transformations prior to persistence. The system can apply authentication policies (e.g., API keys, OAuth) uniformly across all requests generated by the integration and rotate credentials according to organization policy.

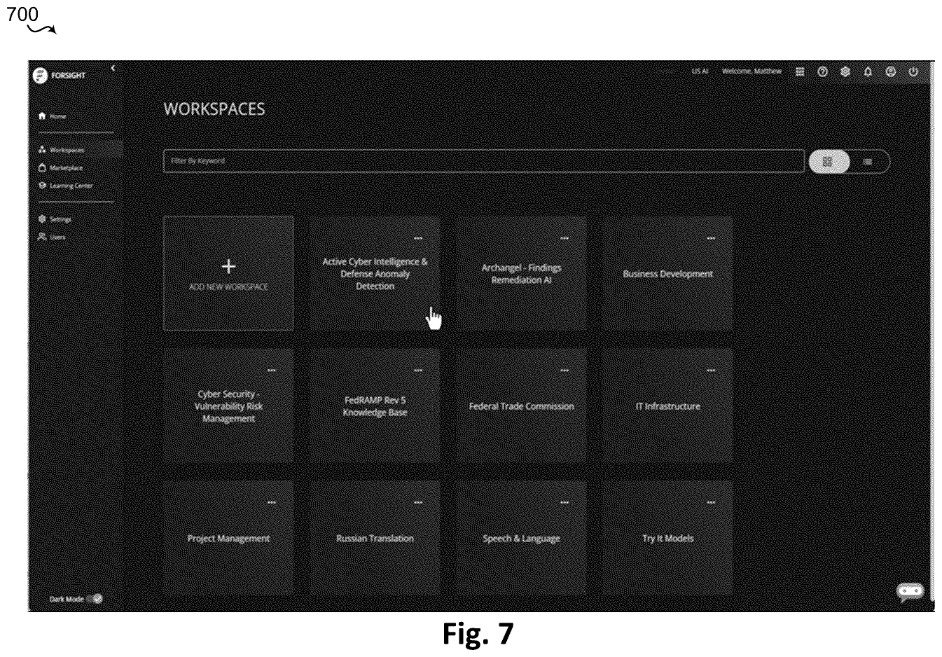

Referring to FIG. 7, a diagram 700 of an example interface for workspaces in accordance with an example implementation is provided. For example, diagram 700 illustrates a system for workspaces that facilitates collaboration, development, security, and deployment of workflows, models, and integrations. Workspace owners have the capability to invite collaborators to participate in the building and configuration of models and workflows. Each workspace is fully isolated within the customer's private tenant to ensure data security, preventing the risk of data exfiltration or spillage. This isolation ensures that sensitive business data remains protected during the collaborative process.

In an aspect, the multi-generative model pipeline allows for workspace configurations to be published to either a public or private marketplace. This feature enables project teams to clone pre-existing configurations and utilize them as a starting point for new projects, thereby accelerating development and ensuring consistency across teams. This system of isolated workspaces, combined with the marketplace capabilities, represents a novel and non-obvious method for securely managing and deploying AI models and workflows within a collaborative business environment.

In an aspect, the multi-generative model pipeline further provides a system and method for managing and deploying a library of generative AI models within an enterprise environment. For example, the multi-generative model provides capability to create and maintain a library of base models, which may be made accessible to various teams within the organization. Each model within the library is subject to regular scanning and validation procedures to identify potential vulnerabilities, ensuring the security and integrity of the models. Changes to models are tracked through version control, allowing for historical records of modifications and updates. Additionally, model owners within the system can choose to publish their models to either a public or private marketplace, making the models available for broader use, either internally or externally.

In some implementations, workspaces may operate as fully isolated tenants within a customer's private environment, and each workspace can be published to a marketplace in either public or private visibility modes. When a workspace configuration is cloned from the marketplace, the system instantiates a new, isolated copy of all referenced assets, including model configurations, integrations, prompts, and data mappings, while preserving references to versioned artifacts to ensure reproducibility.

In support of collaborative development, the system may maintain role-based access controls at the workspace level and records an immutable audit log of changes to models, integrations, prompts, and schedules. Each change event is time-stamped, associated with a user identity, and includes a diff of the modified configuration to facilitate traceability and rollback.

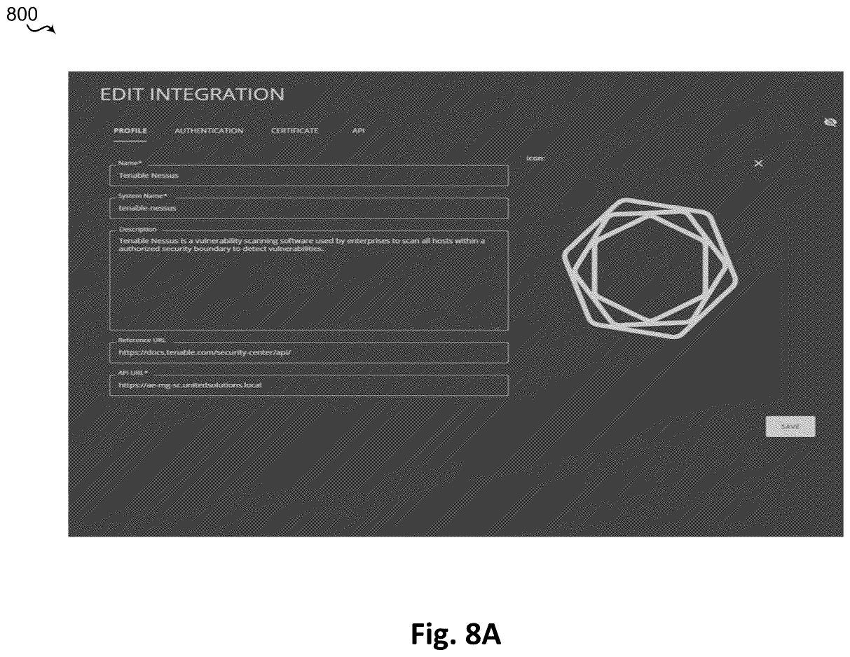

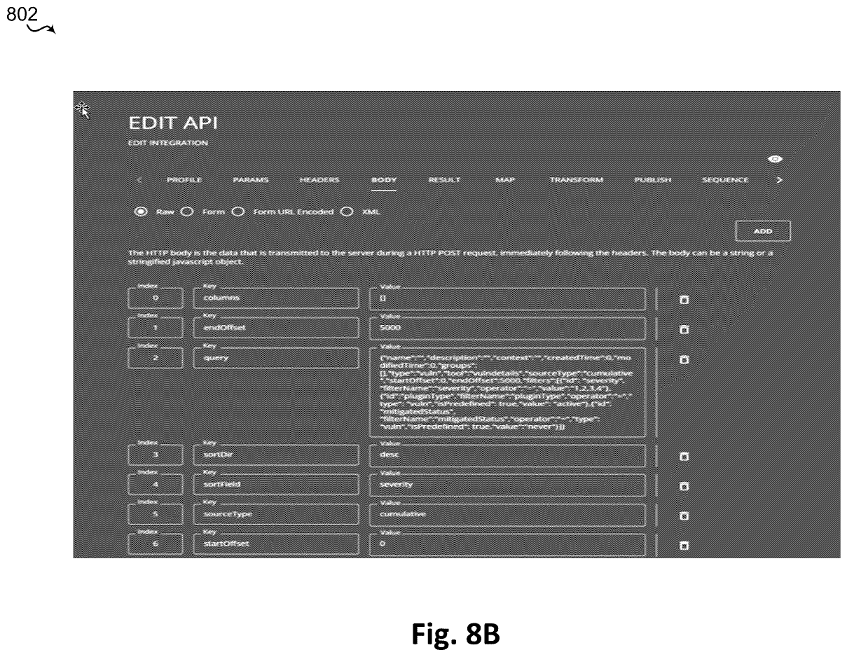

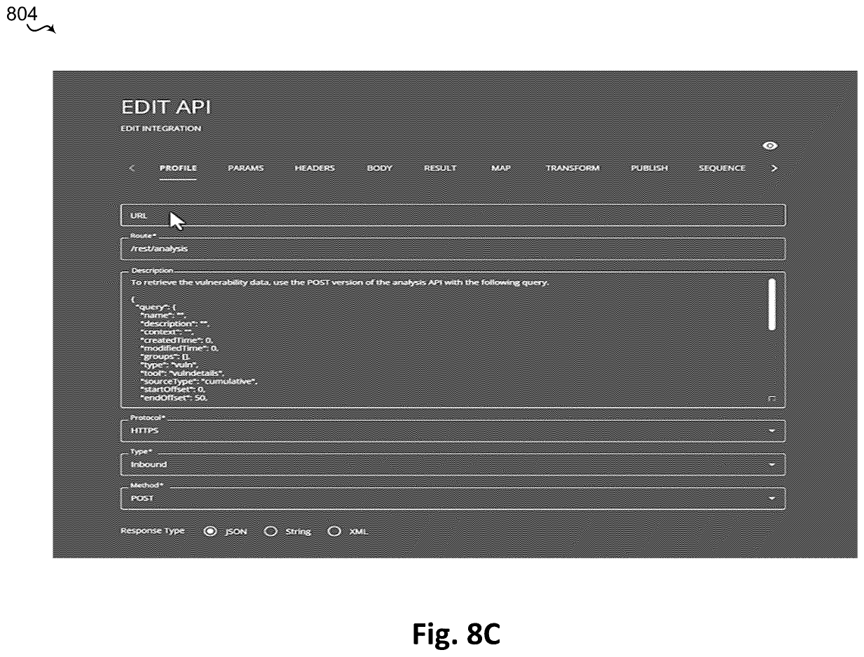

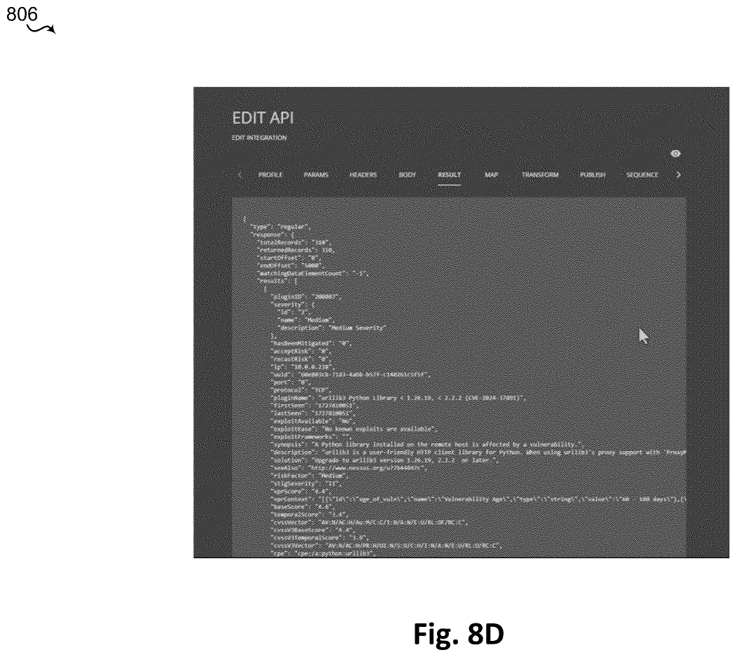

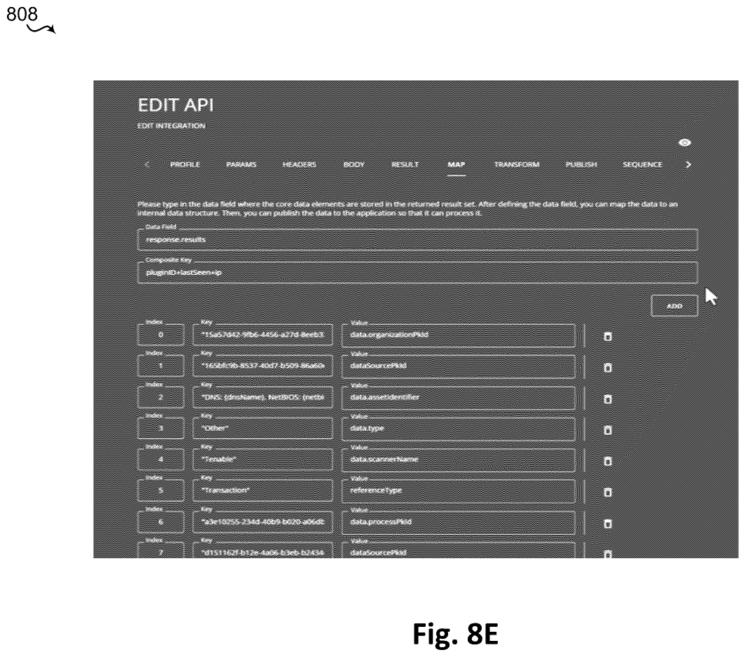

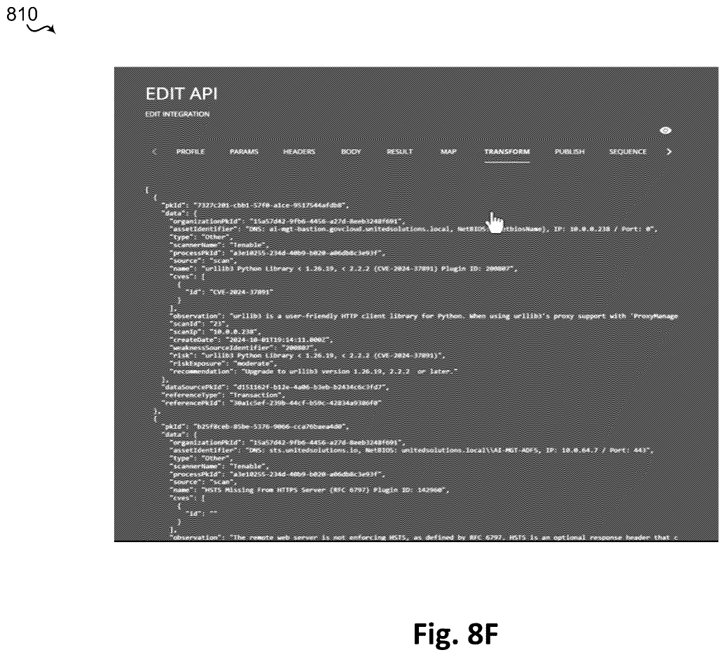

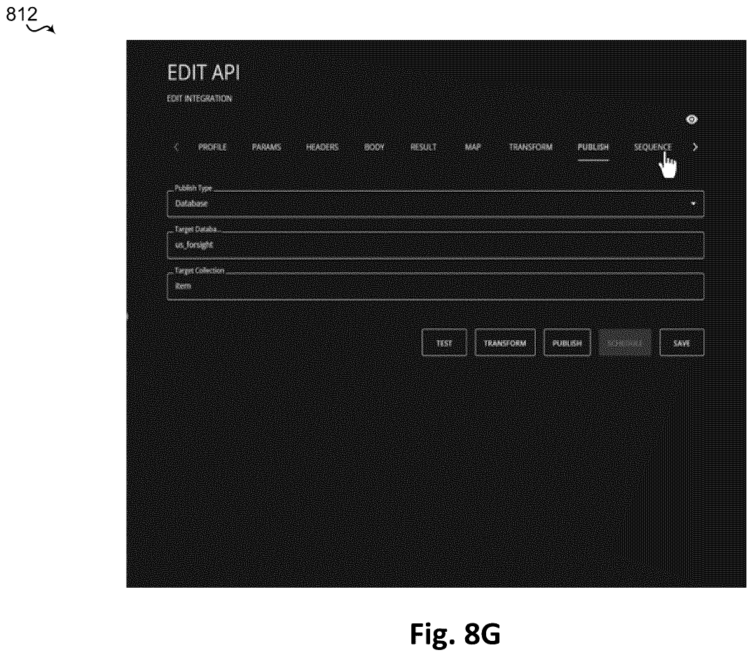

Referring to FIGS. 8A-8G, diagrams 800-812 are an example process for a global integration factory in accordance with an example implementation is provided. For example, the diagrams illustrate the multi-generative model pipeline, including building an integration 800, creating and/or editing an API 802, configuring parameters of the API 804, testing the integration 806, mapping data 808, transforming data 810, publishing data 812, sequencing data, and scheduling the integration.

In an aspect, the global integration factory of the multi-generative model pipeline is compatible with both relational and NoSQL databases. Through this integration service, users and/or businesses are provided the ability to build integrations to any data source or endpoint in a codeless manner. The integration service further enables the collection of data at scale, supporting the ingestion of gigabytes, terabytes, and petabytes of data, which can be critical for enterprises managing large datasets. The multi-generative model pipeline allows for the collection, transformation, and curation of data to be configured and managed by non-technical users, such as business personnel, thereby reducing the dependence on highly specialized systems engineers. Additionally, the integration service includes plug-in microservices designed to automate the entire data pre-processing workflow. These microservices pre-process data in real time, enabling efficient and scalable data management prior to its injection into the AI models.

In an aspect, for the step of building the integration, the integration framework is established, either by creating a new API integration or editing an existing one. During this stage, the system creates a blueprint for how the integration will function. This may include defining the API endpoints, protocols (e.g., REST, SOAP), authentication methods (e.g., OAuth, API keys), and other structural elements necessary for communication between systems. Additionally, the system may provide template-driven options for common API use cases, simplifying the setup. The interface for building the integration includes user inputs for API endpoint creation, connection settings, and basic configurations. The interface also features a user interface with dropdowns and input fields for configuring API methods (GET, POST, etc.) and authentication types.

In an aspect, for the step of creating and/or editing APIs, users create the necessary API endpoints or modify existing ones to ensure the integration meets their data exchange requirements. At this step, the API is connected to the relevant services, and advanced parameters are set. This includes defining request methods, setting timeouts, handling retries, and establishing secure communication channels. Additionally, API versioning may be managed here to ensure backward compatibility and consistent data handling. The interface for creating and/or editing APIs includes a detailed API configuration panel, including areas where developers can input specific settings for the API, such as headers, parameters, and body data.

In an aspect, for the step of configuring parameters, the fine-grain parameters of the integration are configured, which control how data flows between systems. Users may define data limits, rate limits, and error handling rules at this stage. For instance, users may set the maximum number of API requests per second or establish data chunk sizes for efficient transfer. Parameters for pagination, sorting, and filtering may also be defined here, allowing greater control over how data is fetched and processed. The interface for configuring parameters includes configurable fields for setting limits on the size of data pulls, retry settings for failed data transfers, and settings for handling timeouts or other contingencies.

In an aspect, for the step of test integration, users test the API integration to ensure that it works as intended before moving to production. During testing, the system sends test API requests to the source or destination system and logs the responses. The tests may include various scenarios like sending invalid data, testing under load, or simulating network failures to ensure that error handling mechanisms are in place. Logs from the test runs are stored, allowing developers to troubleshoot any issues. The interface for test integration includes outputting a real-time output panel displaying the status of test runs, including HTTP status codes (e.g., 200, 404, 500), response times, and any error messages encountered.

In an aspect, for the step of mapping data, the user ensures that fields from the source system correctly correspond to fields in the destination system. The system provides a mapping interface where users can define field-level transformations. This includes mapping fields between different formats (e.g., converting a date format from MM-DD-YYYY to YYYY-MM-DD), renaming fields, or even combining multiple source fields into a single destination field. This ensures that data integrity is maintained during transfer. The interface for mapping data includes a mapping table where fields from the source and destination systems are aligned, with options for field transformations, default values, and data type conversions.

In an aspect, for the step of transforming data, the system allows data to be transformed according to business rules before it is sent to the target system. Data transformation may involve filtering records, changing data formats, or applying conditional logic (e.g., only sending records where a specific field meets a criterion). Data transformation may also include converting numeric values, string manipulation, or even data enrichment processes (e.g., augmenting data with additional third-party information). The interface for transforming data may include a transformation rule builder with options for defining conditions, applying filters, and executing format conversions. It may also include drag-and-drop functionality for defining transformation flows.

In an aspect, for the step of publishing data, the data may be published or sent to the target system after the data has been mapped and/or transformed. Publishing involves sending the processed data to the final destination via the API. This step may include confirming that the data has reached the target and logging the completion status. The system may also provide options to queue data for later publishing if certain conditions (e.g., network congestion or server load) are met. The interface for publishing data includes a real-time progress bar or status indicator showing the successful publication of data, with logs indicating the number of records successfully transferred.

In an aspect, for the step of sequencing data, the system sequences the data into smaller, manageable chunks for better performance from larger datasets. The system splits large datasets into smaller partitions and processes them sequentially or in parallel. Sequencing helps improve the performance of data transfers by reducing the size of each individual request and avoiding potential API rate limits. After processing, the smaller chunks can be recombined into the full dataset.

In an aspect, for the step of scheduling integration, users can schedule integrations to run at specified times or intervals, allowing for automated, recurring data exchanges. Scheduling options may include one-time, daily, weekly, or on-demand runs. The system may execute multiple integrations in parallel to optimize throughput, especially for high-volume data flows. Additionally, users can define dependencies between integrations, ensuring that certain jobs only run after previous ones are completed successfully.

In some implementations, each integration can be scheduled and executed in a partitioned manner to optimize performance on large datasets. The scheduler can segment data into discrete chunks based on user-defined partition keys (e.g., time ranges, identifiers) and process those chunks in parallel workers. Upon completion, the system merges the processed partitions into a single curated dataset while preserving global ordering via a stable sort on the partition key and a monotonic sequence attribute assigned at ingest.

In the same aspect, the system may expose configuration parameters for concurrency, backoff, and retry semantics at the step level. For example, a user can specify maximum concurrent requests, retry counts per failure class, and exponential backoff coefficients. The system records partition-level lineage and emits per-chunk metrics such as throughput, error rate, and latency, which are made available in the pipeline monitoring interface.

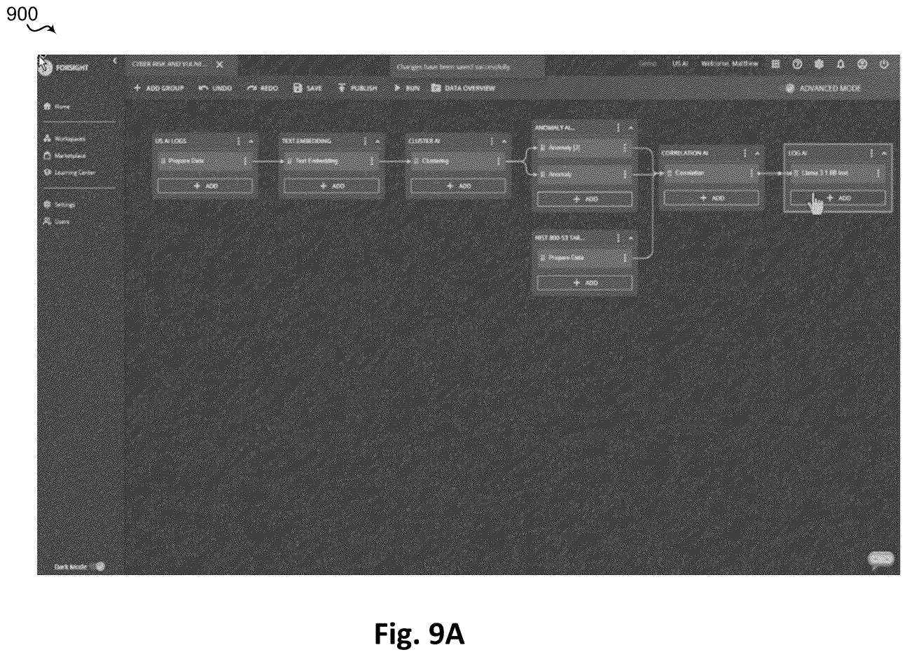

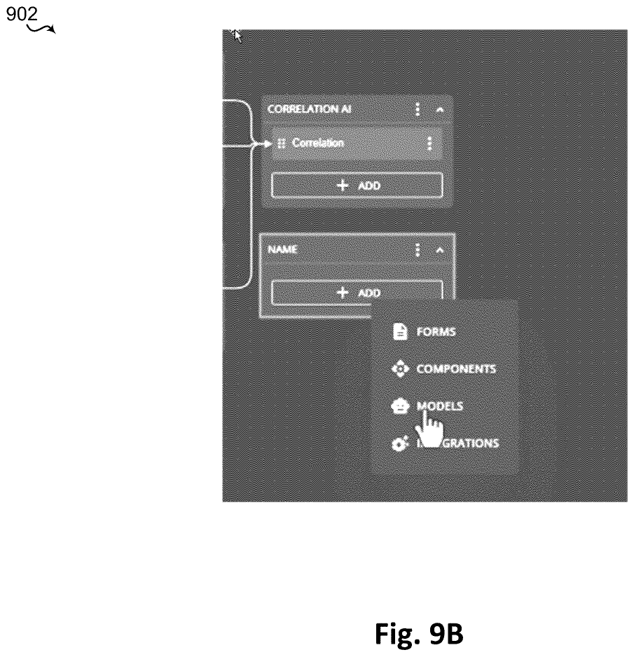

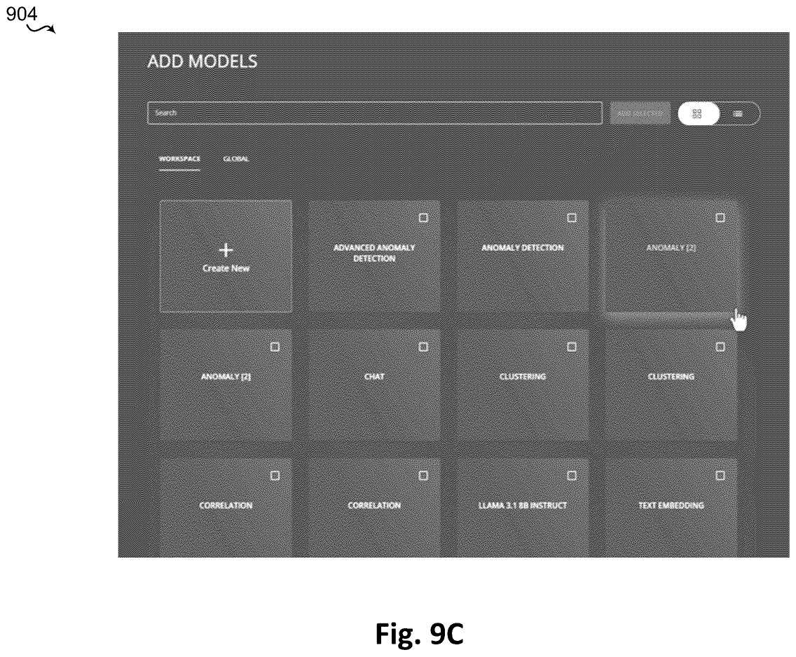

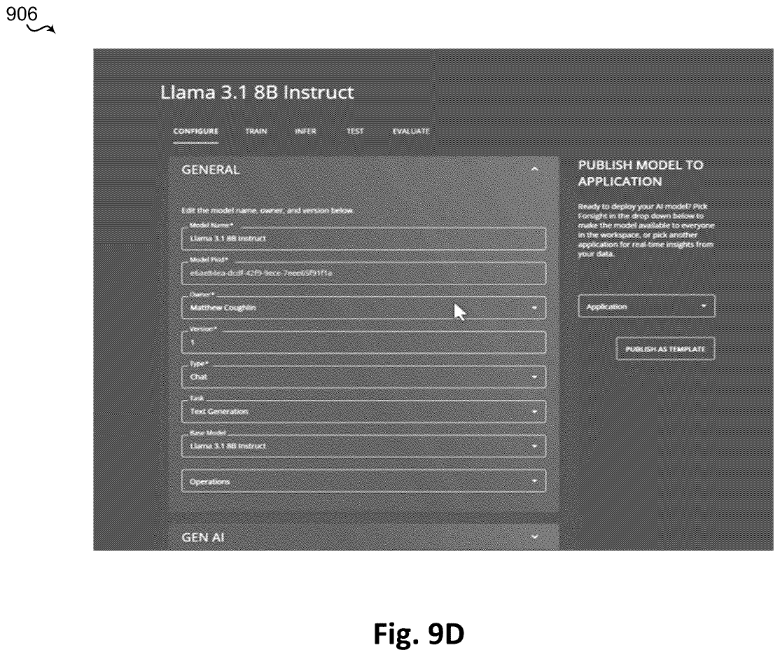

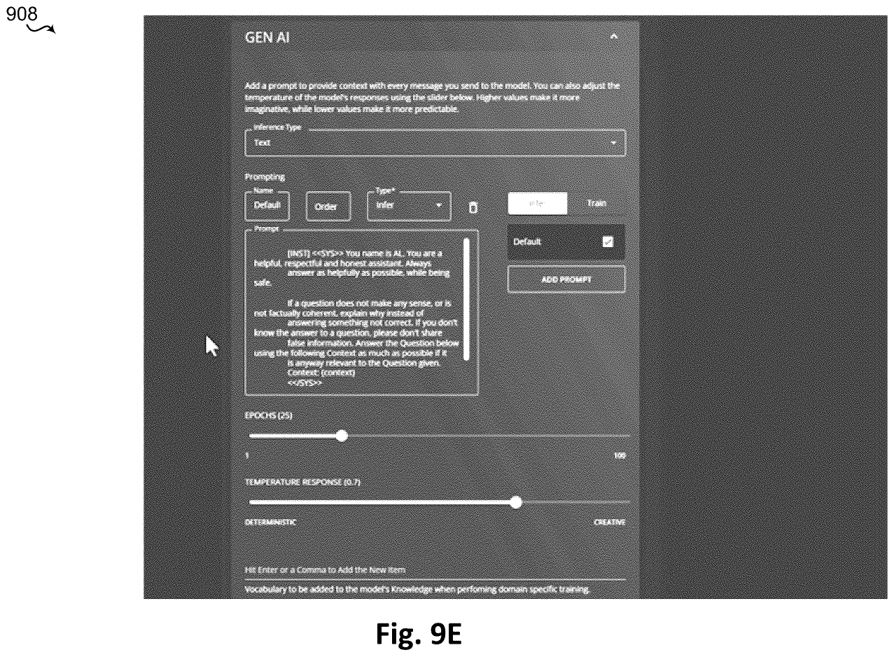

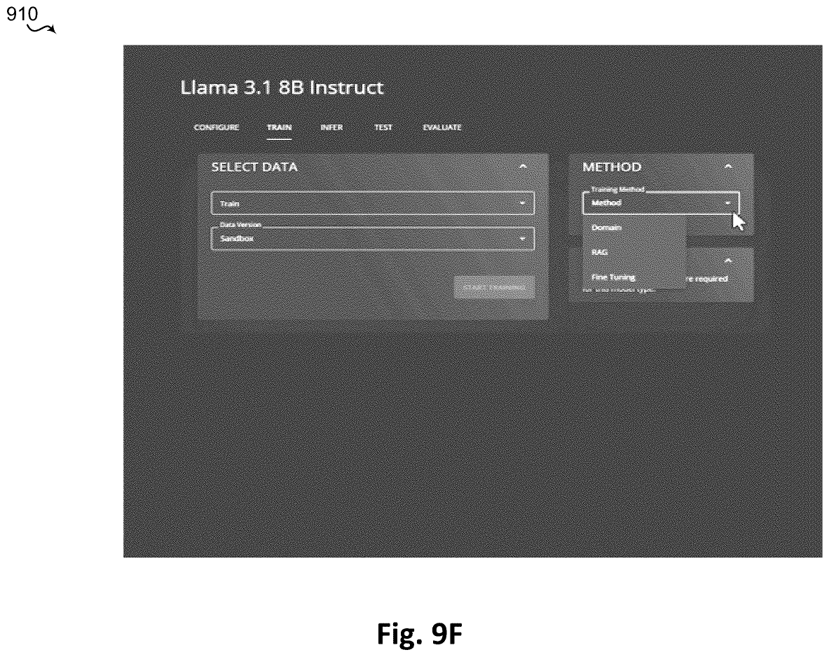

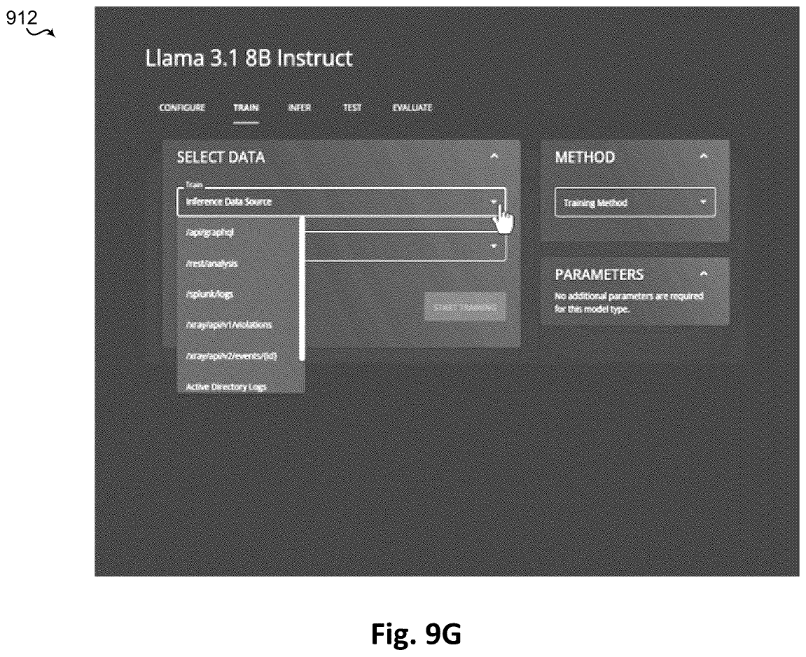

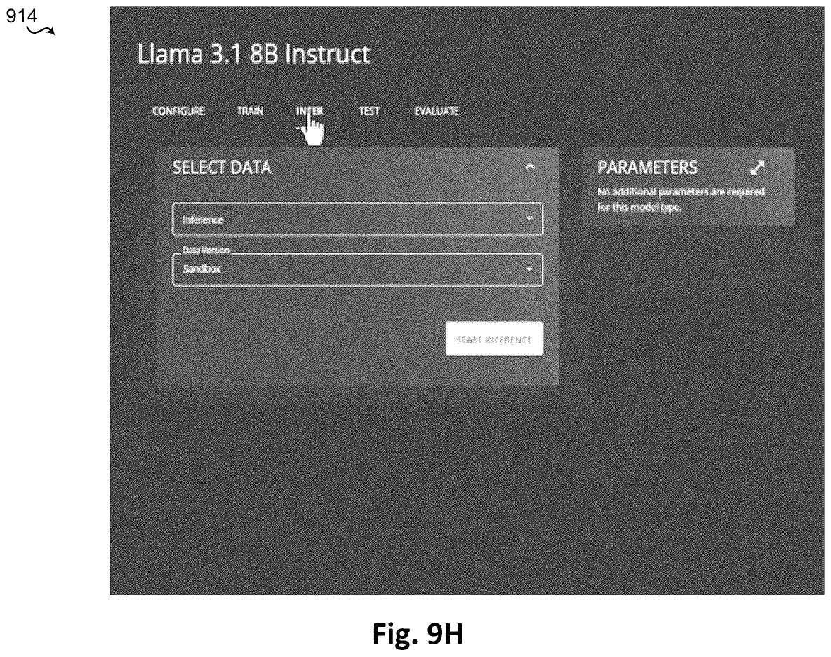

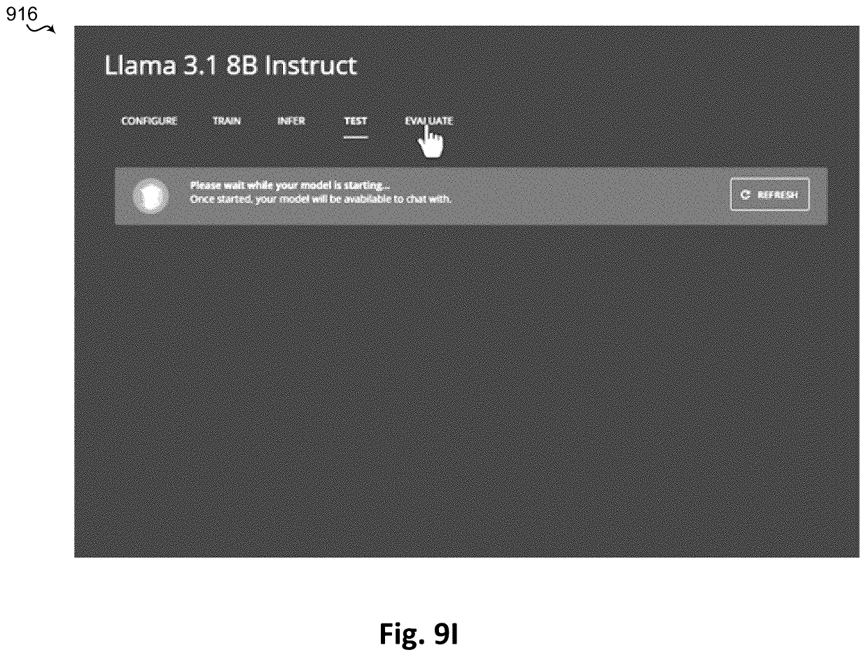

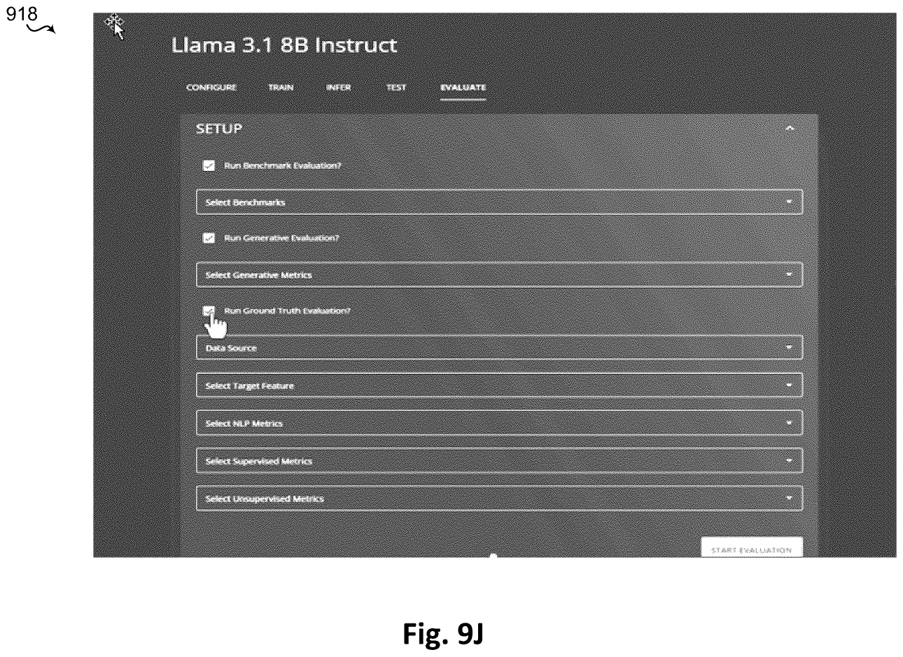

Referring to FIGS. 9A-9K, diagrams 900-918 of an example process for building and chaining generative and classical AI models in accordance with an example implementation are provided. For example, the diagrams illustrate the multi-generative model pipeline, including building and chaining models 900, adding models 902, selecting a model 904, configuring the model 906, configuring a prompt 908, training the model 910, selecting data 912, configuring inference 914, testing the model 916, and evaluating the performance of the model 918.

In an aspect, the multi-generative model pipeline is configured to allow users to design a complete AI pipeline. In one implementation, each step in the pipeline is configurable to pull data from any data source using an integrated service. The system allows for data to be injected into a dynamic database that is configurable in-process. This feature enables the database to adapt to newly injected data, ensuring that models within the pipeline can evolve and continuously learn from new knowledge and data sets. Furthermore, the multi-generative model pipeline transfers data between models by employing a vertical database design structure. This structure is scalable by virtue of a unique process of data segmentation, which allows for efficient and scalable data transfer between the various models in the pipeline. The vertical database design ensures that each model in the chain receives the appropriate data for processing, thereby overcoming the traditional limitations of model chaining in AI workflows.

In an aspect, the multi-generative model pipeline provides a set of foundational microservices, containers, and data models designed to standardize the workflow for building and deploying AI models. The system enables data scientists to develop and edit models directly in an integrated editor while automating the approval of code changes and subsequent deployment. The automation is facilitated by a robust infrastructure of microservices that manage code versioning, modularity, and configuration, significantly reducing the manual overhead associated with deployment processes.

Further, the models can be easily adjusted and modified without extensive reworking of code. This flexibility, combined with a system for data exchange between models, allows the creation of a marketplace for data and models. Such a marketplace, enabled by this multi-generative model pipeline, allows businesses and individuals to exchange, purchase, and integrate AI models and data sources in a standardized, interoperable manner, overcoming traditional barriers related to costs, delays, and the lack of reusable code structures. The prerequisite for this marketplace is the carefully designed set of standards, microservices, and infrastructure that the invention provides, ensuring compatibility and seamless integration across models and workflows.

In an aspect, the multi-generative model pipeline collects tacit data through crowdsourcing mechanisms, specifically for use in classical and generative AI models. Traditional AI systems primarily rely on structured data sources, such as databases, spreadsheets, and external data feeds. However, the multi-generative model pipeline recognizes that the most valuable data for AI training may often be tacit—that is, knowledge that resides in the minds of individuals rather than in structured databases.

The multi-generative model pipeline enables a user or businesses to design data models that define specific data fields and types needed for AI model training. Through the platform, data owners or stewards are able to create and distribute dynamic forms to request and crowdsource the collection of this tacit data from individuals or groups. The forms are distributed through a crowdsourcing mechanism embedded within the platform, allowing businesses to gather and structure this otherwise inaccessible data efficiently.

The collected data can be incorporated into existing data models and used for both classical and generative AI, enabling the AI to learn from the unique knowledge and insights of individuals. The system ensures that the data collection process is dynamic, scalable, and fully configurable, making it adaptable to a wide range of use cases. By integrating crowdsourced tacit data into AI models, the multi-generative model pipeline enhances the AI's ability to make predictions, improve accuracy, and expand its knowledge base in ways that were previously unattainable through traditional data sources alone.

In an aspect, the step of building and chaining models includes the process of constructing and chaining multiple AI models together to address complex problems. Model chaining is configured when multiple models must work sequentially, with the output of one model feeding into the next. Chaining models allows users to combine distinct models that perform unique functions into a cohesive workflow. For example, a model may be used for feature extraction, and its output is passed to another model for classification or inference. This stage requires the ability to integrate models in a way that maintains data flow consistency, error handling, and performance across the chain. The interface for building and chaining models includes multiple models linked in a chain, with arrows indicating data flow between them. Each model might have configuration nodes that allow for customization of how they interact with one another.

In an aspect, for the step of adding models, users are prompted to add a model to the system, which can then be trained, configured, or chained with other models. Adding a model involves selecting from a library of pre-trained models or importing custom models. The system may support various model formats, such as PyTorch, TensorFlow, or ONNX, and provide version control to ensure reproducibility. The interface for adding models may include an interface for adding models, with options for importing, browsing existing libraries, or creating a new model from scratch.

In an aspect, for the step of selecting a model, users choose which model to use from the available library, either selecting an existing model or opting to use a new one. This step involves navigating through available models, which may be categorized by task (e.g., image recognition, natural language processing). Additionally, users may have access to metadata for each model, such as training dataset, performance metrics, and version history. The interface for selecting a model may include a model selection panel, with filters or search options to help users find the model most suitable for their needs.

In an aspect, for the step of configuring models, users configure the internal parameters of the selected model, adjusting hyperparameters or structural configurations (e.g., number of layers, learning rates). During this step, users can tune model parameters such as batch size, number of epochs, dropout rates, and optimization algorithms. Hyperparameter tuning can have a significant impact on model performance, and advanced users might use grid search or random search techniques to find optimal settings. The interface for configuring models may include a user interface where users can configure model parameters, with sliders, dropdowns, and input fields for adjusting various hyperparameters.

In an aspect, for the step of configuring prompts, users may configure prompts to guide model behavior for models that rely on text input, such as natural language processing (NLP) models or generative AI. In this step, users set prompts, which could include specifying input text or other pre-processing steps to prepare data for model inference. The prompt configuration is especially crucial in generative models where the prompt can greatly influence the quality and relevance of the generated output. The interface for configuring prompts may include a prompt configuration window, with input fields where users can define text prompts and adjust how the model processes those prompts.

In an aspect, the step of training models includes adjusting model weights and fine-tuning models for a specific task. The system supports both supervised and unsupervised learning methods. Users may specify the dataset, configure how the model is trained (e.g., full dataset vs. minibatch training), and define validation strategies. GPU/CPU resource allocation may also be handled at this stage to optimize training efficiency. The interface for training models may include a training progress bar, displaying key metrics such as accuracy, loss, and epoch count as the training progresses.

In an aspect, for the step of selecting data, users may choose the data to be used for training or inference to ensure the model learns from relevant and high-quality data. The system may support various data formats (e.g., CSV, JSON, image datasets) and offer preprocessing tools such as normalization, augmentation, or data splitting. Data pipelines may also be configured to automate the process of feeding data into the model. The interface for selecting data may include a data selection interface where users can browse or upload datasets, with options for preprocessing and data transformation.

In an aspect, for the step of configuring inference, users configure how the model will make predictions or inferences based on new data. Configuring inference involves setting input parameters, specifying output formats, and determining batch processing strategies for large datasets. This step may also include configuring how the system handles errors or edge cases during inference. The interface for configuring inference may include options for defining input data formats, as well as checkboxes or toggles for setting output preferences.

In an aspect, for the step of testing models, users run tests on the model to evaluate its performance on validation data or test cases before deployment. The system tests the model's accuracy, precision, recall, F1 score, and other relevant metrics. This step may also involve running stress tests or adversarial tests to ensure robustness. Logs and real-time performance metrics are captured for further analysis. The interface for testing models may include a test results panel, with graphs and charts showing the model's performance across different metrics.

In an aspect, for the step of evaluating models, users evaluate the model's overall performance and determine whether it meets the required standards for deployment or further refinement. Evaluation involves comparing the model's performance to baseline metrics or previous iterations. The system may provide reports that summarize key performance indicators (KPIs) and offer suggestions for improving the model based on the results. The interface for evaluating models may include a comprehensive evaluation report, with charts and tables summarizing the model's performance metrics, and possibly including recommendations for improvement.

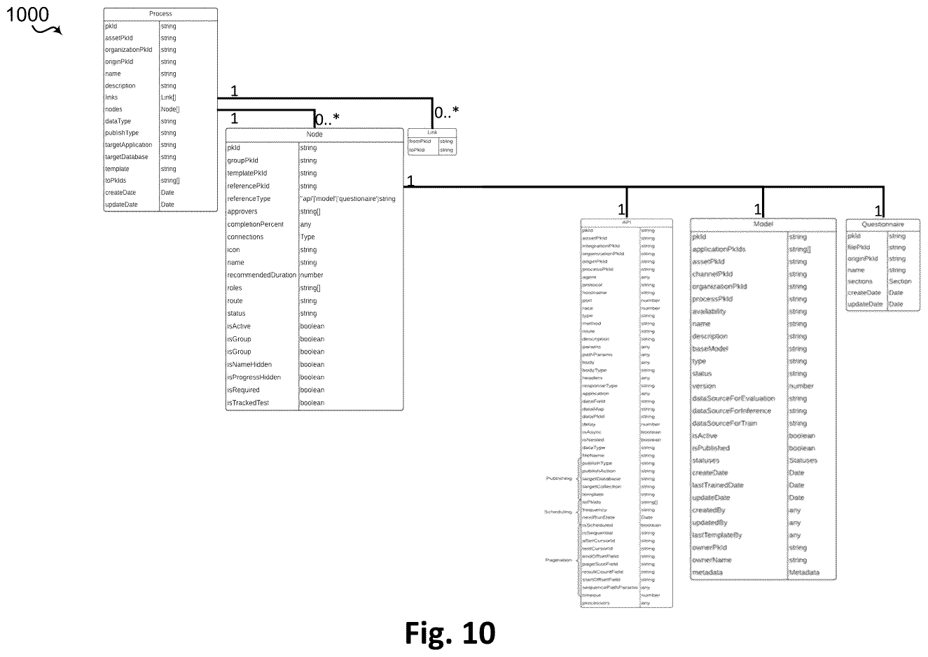

Referring to FIG. 10, a block diagram 1000 of an example codeless workflow for linking processes or steps together in accordance with an example implementation is provided. For example, diagram 1000 illustrates an integrated, codeless workflow builder powered by a flexible data model that enables dynamic linking of processes, steps, and various system components. The codeless workflow builder allows users to build workflows wherein any process or step can be linked together seamlessly, utilizing a scalable, elastic architecture.

In an aspect, the system includes a Process entity, which tracks key metadata associated with each workflow or task, such as processId, name, description, and timestamps for creation and updates. Each process consists of one or more Nodes, which represent individual steps within the process, each identified by a nodeId. These nodes are linked together via the Link entity, which defines directional relationships between nodes (fromNodeId and toNodeId).

The system further provides the ability to dynamically link each Node to various components of the platform, including but not limited to integrations, data science models, and questionnaires. This is accomplished using the referencePkId and referenceType fields, which allow for the flexible association of nodes with external systems, AI/ML models, or user-input mechanisms. The use of generic fields in this structure enables the system to elastically scale, allowing any entity or external resource to be linked to a node as part of the workflow.

Additionally, the system comprises an API entity, which facilitates communication with external platforms and services. This entity tracks API-specific attributes such as apiId, url, methodType, and configurations for headers, query parameters, and authentication (authType). The API entity supports additional features such as pagination and scheduling, allowing for granular control of data flow between systems and services. Through the codeless workflow builder, users can configure API interactions without manual coding, dynamically integrating them into the broader workflow.

The Model entity enables the incorporation of generative and classical AI models into workflows. The system tracks various aspects of each model, including its ID, version, and metadata, and allows for continuous evaluation and integration into processes via dynamic database updates. This model management system provides seamless integration of machine learning models, allowing them to evolve and incorporate new data as they are linked into workflows.

Furthermore, the codeless workflow builder supports a Questionnaire entity, which allows for the creation and management of forms or surveys within a workflow. Each questionnaire is defined by a questionnaireId, with multiple sections and version tracking, allowing for flexibility in user interaction. The use of reference fields and generic data structures enables elastic scalability, allowing it to dynamically link various entities and external resources. This flexibility allows the codeless workflow builder to adapt to an expanding range of use cases, such as integrating API calls, AI models, and user interaction mechanisms, thereby improving the efficiency and scalability of business and technical processes.

In some implementations, the codeless workflow engine may represent processes as a directed acyclic graph of nodes linked by typed edges. Each node can reference an external resource via a reference primary key and reference type, including but not limited to an integration, data model, AI/ML model, or questionnaire. The engine enforces dependency constraints such that a child node is eligible for execution only after all of its parent nodes have completed successfully.

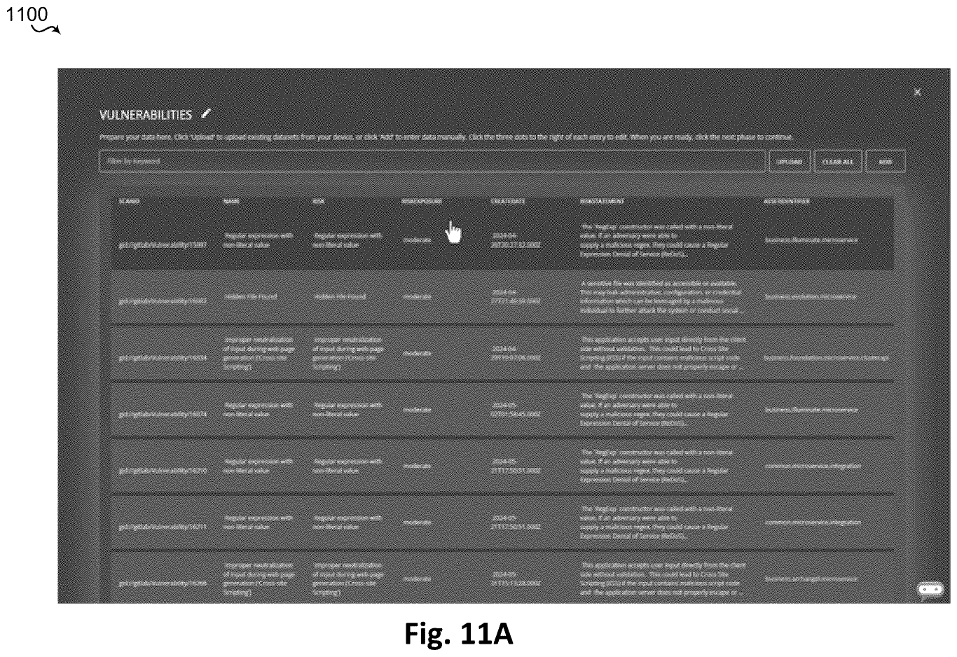

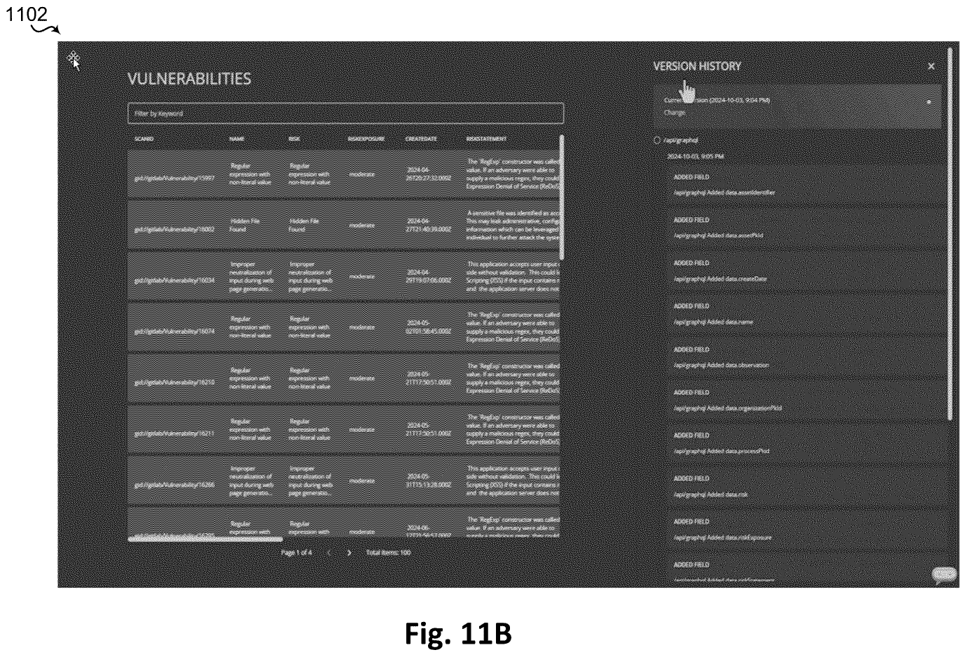

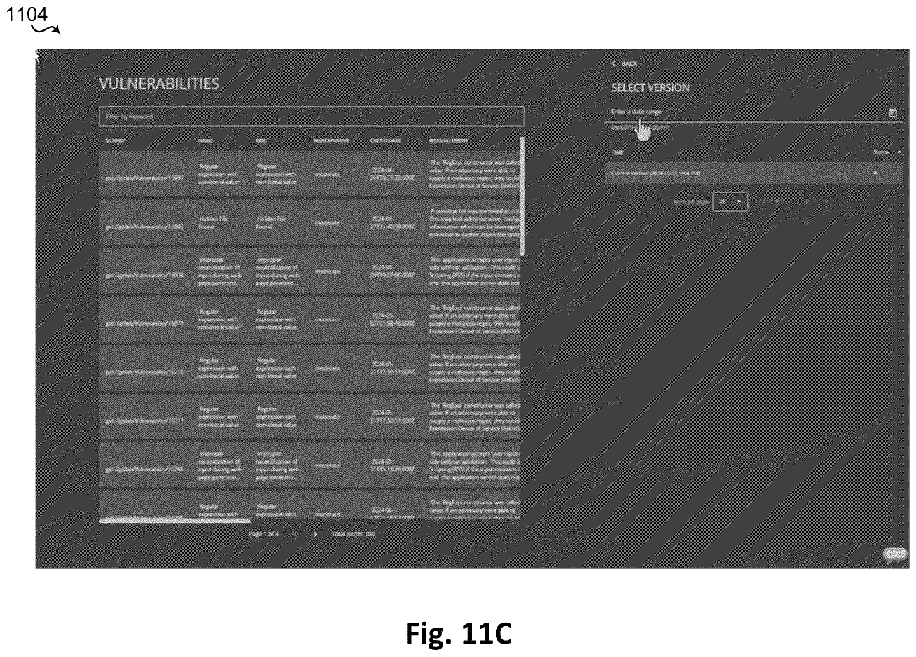

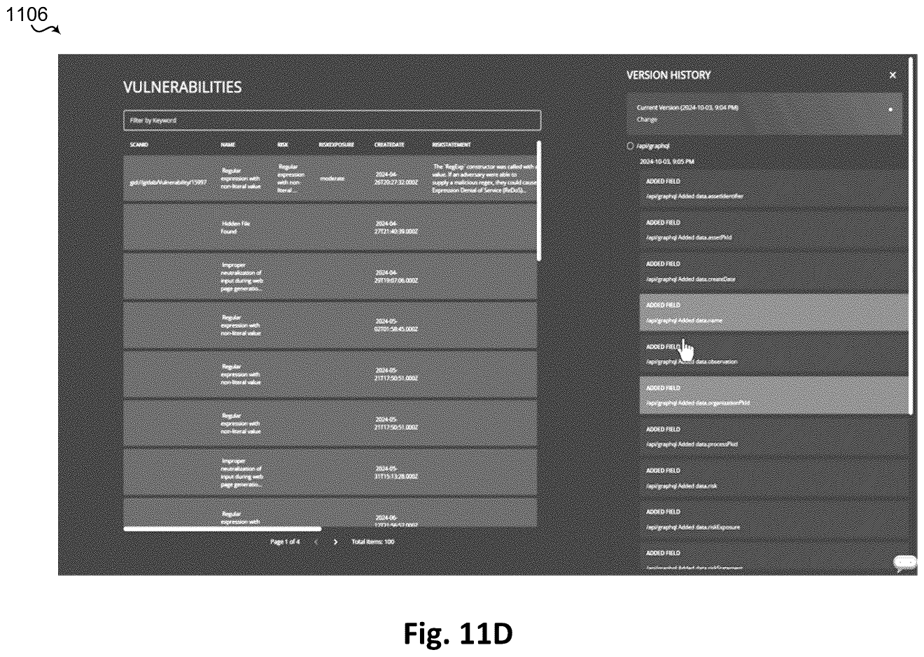

Referring to FIGS. 11A-11D, diagrams 1100-1106 of an example process for management of data lineages in accordance with an example implementation are provided. For example, diagrams 1100-1106 illustrate managing data lineage, provenance, and change management within generative AI models to ensure that the lineage, provenance, and changes applied to the data are transparent, traceable, and auditable by both humans and machines. In this example, the multi-generative model pipeline provides the user the capability to browse data catalog, manage data, browse data lineage, track changes by time period, and monitor dynamic fields being added.

In an aspect, the multi-generative model pipeline configures the collection, cleansing, enrichment, and transformation of data before it is injected into AI models. Specifically, a user and/or businesses are able to curate and manage data in a manner that mitigates risks such as bias, discrimination, and fraud. Once curated, the data can be split into subsets or recombined for various uses, such as testing, training, or other machine learning applications.

The multi-generative model pipeline provides visibility and traceability of data transformations through a data service. This data service ensures that all changes to the data are logged and visible to the model owner or designated auditor. The system provides real-time tracking of data lineage, enabling end-to-end transparency of the data's origins and transformations. As a result, users can audit the models, including their inputs, transformations, and outputs, to ensure the ethical and trustworthy application of machine intelligence.

The system further provides mechanisms for auditing data provenance, enabling users to trace the source of data, its transformations, and its use in generating AI outputs. This traceability allows for real-time auditing by either a human or machine, ensuring that any changes to the data or models are fully transparent and documented. The ability to audit the data in real time ensures that the AI models adhere to standards of ethical behavior and regulatory compliance.

In an aspect, for the step of browsing data catalogs, users may explore the available data within the system through a data catalog interface. A data catalog serves as a repository that lists and describes all available datasets, including metadata such as source, structure, and ownership. Users may search, filter, and browse through datasets to identify the ones relevant to their specific use cases. The catalog may also display details like data quality metrics, last updated timestamps, and security classifications, helping users to make informed decisions about which datasets to use. The interface for browsing data catalogs may include a search bar, data categories, filters, and descriptions for each dataset. The interface may also provide detailed metadata for each item in the catalog.

In an aspect, for the step of managing data users may interact with datasets by modifying, updating, or enriching the data. Managing data involves tasks such as data curation, cleaning, and validation. Users may modify datasets by adding or removing fields, correcting errors, or enriching data with external sources. The system may also support access control mechanisms, where only authorized users can make modifications to sensitive datasets. Data lifecycle management may also be a part of this process, where users can archive or delete obsolete datasets. The interface for managing data may include an interface where users can select a dataset and apply changes through an action panel, which might include buttons for editing, validating, and cleaning data. The interface may also include options for managing dataset permissions and collaboration.

In an aspect, for the step of browsing data lineage, users may view the lineage of a dataset, which is critical for understanding where data comes from, how it has been transformed, and where it is being used. Data lineage provides a visual representation of the flow of data through the system. The data lineage shows the origin of data, the transformations it has undergone, and its destination allowing users track the lifecycle of data, ensuring transparency, auditability, and compliance with regulations. The system may allow users to visualize both upstream and downstream dependencies of the dataset, giving a complete picture of how changes to one dataset can affect others. The interface for browsing data lineage may include a flowchart or graphical representation of the data lineage, with arrows indicating how data moves through various stages of transformation and usage. The interface may display connections between datasets and systems where the data is consumed.

In an aspect, for the step of tracking change by time period, users may track changes in datasets over time, providing a historical view of modifications and transformations. The system captures and tracks all modifications to a dataset, including updates, deletions, or transformations. This historical tracking allows users to audit changes and investigate issues or discrepancies that may arise over time. Tracking by time period may also help in version control, where users can roll back to a previous version of the dataset if necessary. This is especially important for compliance and regulatory requirements where data history needs to be maintained. The interface for tracking change by time period may include a timeline or interface where users can select a specific time period and view the corresponding changes made to the dataset. Each modification might be annotated with user details and timestamps.

In an aspect, for the step of monitoring dynamic fields being added, users may monitor dynamic fields being added to datasets in real-time. Monitoring dynamic fields involves tracking fields that are added to a dataset dynamically, possibly as new data sources are integrated or as new attributes are identified during data collection processes. This feature ensures that users are aware of structural changes to datasets, which could affect data integration, reporting, or analysis workflows. The system may provide alerts or notifications when new fields are added, allowing users to assess the impact of these changes. The interface for monitoring dynamic fields may include a live dashboard where users can see newly added fields and related metadata. The interface may also include visual cues such as color changes or notifications to highlight new fields added to the datasets.

In some aspects, the data catalog and lineage views may provide end-to-end traceability across raw, source, and curated data stores. The system records version history for each dataset, including structural changes such as field additions, deletions, and type modifications. Users can select a time period to view changes applied during that interval and inspect a visual lineage graph showing upstream sources, applied transformations, and downstream consumers.

In the same aspect, the system may monitor dynamic field additions in real time and flags newly observed fields for review. For each new field, the system captures metadata such as origin, first-seen timestamp, inferred data type, and sample values. Administrators can approve or quarantine dynamic fields and apply normalization rules that are automatically propagated to downstream transformations and models.

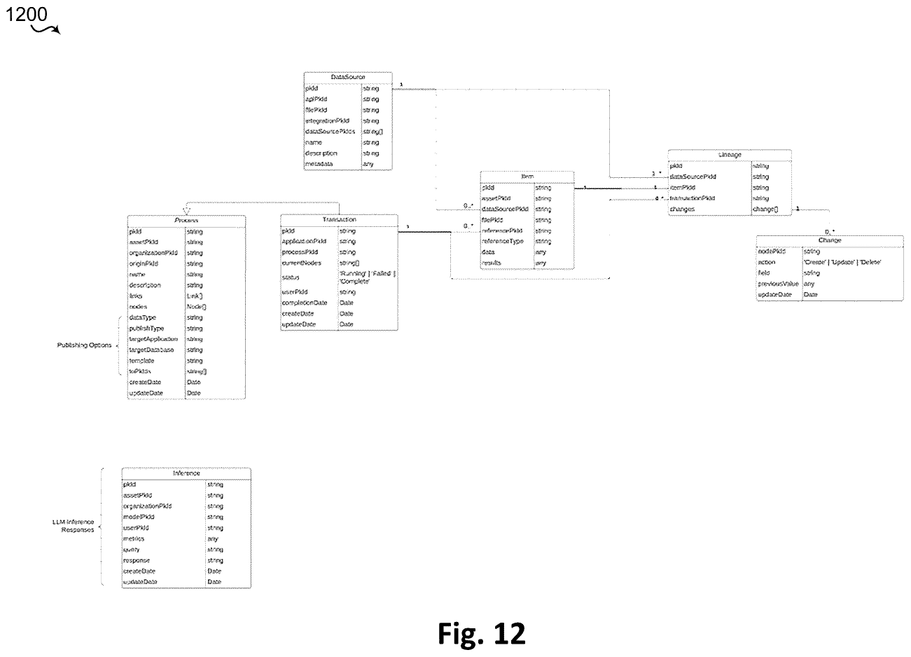

Referring to FIG. 12, a block diagram 1200 of an example vertical database for dynamic data transformation in accordance with an example implementation is provided. For example, diagram 1200 illustrates managing and scaling data across multiple AI models and microservices using a vertical database design.

The system enables the use of vertical database design to transform and share data between AI models and microservices, addressing the scalability issue by dynamically distributing workloads. The system architecture leverages a flexible data model that integrates with AI models, microservices, and processes. The architecture ensures that as data scales, new databases or data collections are automatically generated, and each is linked using a unique identifier. This identifier ensures that all data remains interconnected, providing a uniform structure across the system, thereby ensuring complete traceability and data provenance.

The system stores data across three distinct databases: raw, source, and curated. The raw database stores unprocessed data, the source database stores transformed data for intermediary use, and the curated database holds fully processed and enriched data, ready for use in AI models and microservices. The use of these distinct databases allows for clear separation of data stages, ensuring data integrity and reducing risks of corruption or loss during processing.

In an aspect, when the system detects that data processing or storage has reached a scalability threshold, it generates additional databases or collections, each assigned a unique identifier that links the new collection back to the original data set. This process ensures that data can be scaled horizontally without compromising performance or traceability. The system architecture also allows for seamless integration between processes, AI models, and microservices by employing a uniform naming convention to maintain consistency and interoperability between components.

Further, the multi-generative model pipeline enables dynamic selection of data sources, collections, and fields for training and running AI inferences. For example, the multi-generative model pipeline allows users, rather than just data scientists, to participate in the scenario-building process. The system enables users to dynamically select and configure various data sources, data collections, and specific data fields for use in training generative AI models and executing AI inferences. By empowering users to curate and manage the data inputs for AI models, the invention ensures greater transparency, fostering trust in the outputs of the AI systems.

In an aspect, the system includes a user interface that allows business users to select from various data collections and fields, which are then used to train the AI model or run scenario-based AI inferences. The system dynamically integrates these selected data inputs into the AI model's training process, allowing users to modify and experiment with different data combinations in real time. This configurability not only improves the ethicalness of AI models by allowing for comprehensive scenario analysis but also enables better alignment with business objectives, as users can select data that is relevant and contextually appropriate for their specific use cases.

Furthermore, the system tracks and logs the selected data sources and fields used for each scenario, providing full auditability and ensuring that business leaders have insight into how the models were trained and what data was used for running inferences. This transparency provides a foundation for ethical AI development, as businesses can ensure that models are built and operated on data that aligns with ethical standards and organizational goals.

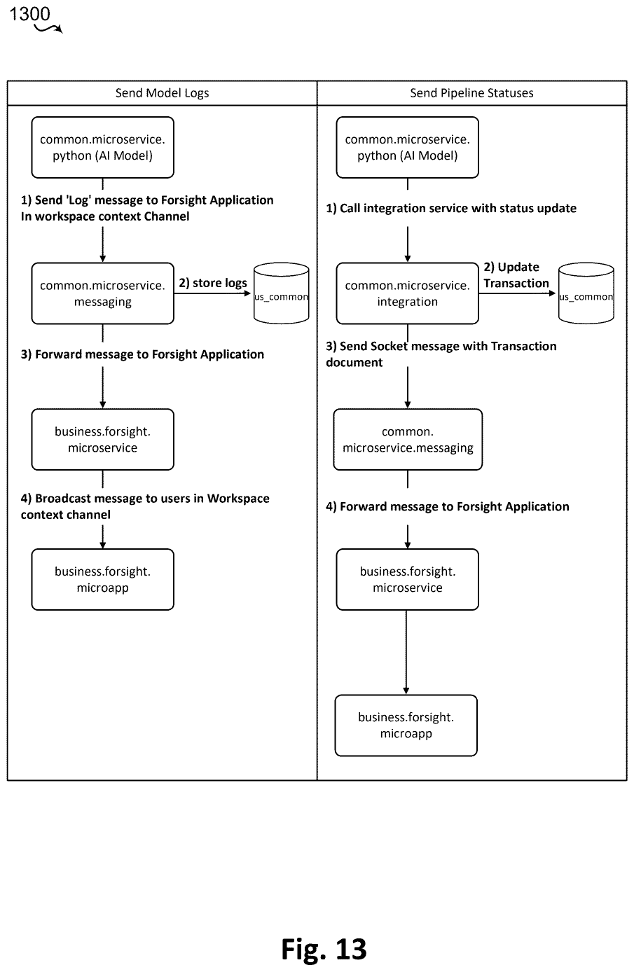

Referring to FIG. 13, a block diagram 1300 of an example of configurable data pipelines and native integration with cloud infrastructure in accordance with an example implementation is provided. For example, diagram 1300 illustrates configurable data pipelines and enabling native integration with cloud infrastructure, allowing businesses to monitor and manage the health, quality, and performance of their data pipelines in real-time.

In one aspect, the system allows users to configure data pipelines that collect, transform, and curate data in preparation for use by AI models. These pipelines can be dynamically adjusted to accommodate new data sources and endpoints, ensuring that AI systems receive high-quality, relevant data for analysis and inference. Moreover, the system includes a mechanism to publish endpoints, enabling the operationalization of AI-generated intelligence directly into business applications, thereby streamlining the deployment of AI insights into the broader business ecosystem.

In an aspect, the system provides real-time tracking and monitoring of pipeline performance through its native integration with cloud infrastructure. This integration allows businesses to continuously assess the health and quality of the data pipelines, ensuring that they operate efficiently and that any performance degradation is immediately detected and addressed. By leveraging cloud infrastructure, the system enables scalable and affordable pipeline execution, optimizing the utilization of valuable computational resources while maintaining data integrity and throughput.

Additionally, the system allows businesses to autonomously activate business processes, including product development and go-to-market strategies. For instance, upon uncovering a new market opportunity using AI, the system can autonomously trigger processes that activate the product development and sales organizations to build and launch a new product in a dramatically shortened timeline, such as within one month. This capability to configure and deploy AI-driven insights directly into operational workflows offers users and/or businesses the ability to accelerate decision-making and execution, a capability not commonly available in today's market.

Furthermore, the ability to configure AI models and integrate them into the application ecosystem provides users and/or businesses with flexibility. The native integration with cloud infrastructure ensures that the system can scale safely and affordably, optimizing the use of infrastructure resources and reducing operational costs. This integration also enhances the system's robustness, ensuring that pipeline configurations can be managed with minimal risk while maximizing performance and scalability.

In some implementations, the messaging subsystem may enable AI model containers and microservices to emit structured log and status events into a workspace-scoped channel. Events may be persisted in a common transaction store and simultaneously broadcast to subscribed user interfaces via sockets. This event fabric decouples producers from consumers, allowing real-time monitoring, alerting, and backpressure management without requiring direct point-to-point integrations.

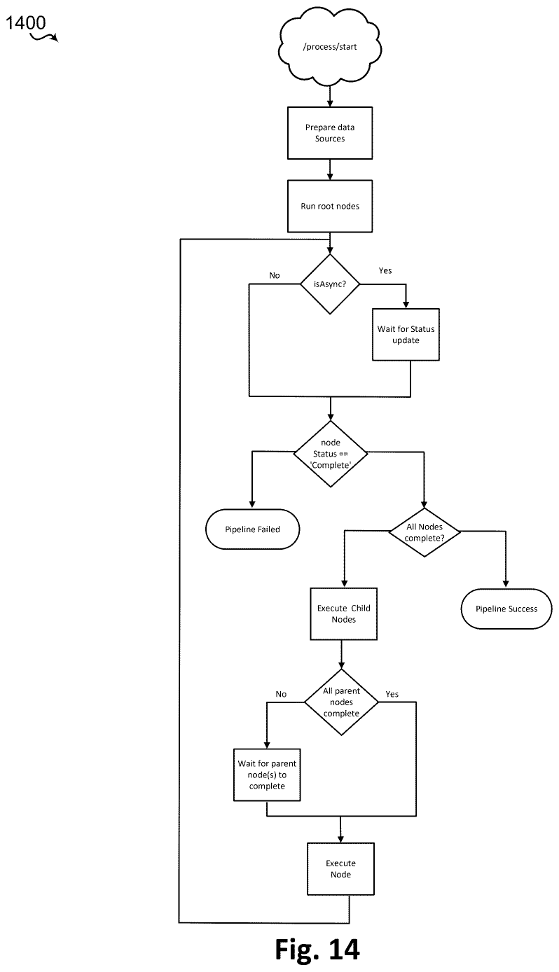

Referring to FIG. 14, a flowchart 1400 of an example configurable data pipelines and native integration with cloud infrastructure in accordance with an example implementation is provided. For example, flowchart 1400 illustrates managing the execution of data pipelines, wherein the system incorporates both asynchronous and synchronous processing of nodes within the pipeline to ensure efficient execution and data integrity. The system enables dynamic control over pipeline execution, including the handling of dependencies between nodes, the real-time monitoring of node status, and the seamless integration of failure detection mechanisms.

In one implementation, the process is initiated at the/process/start point, which triggers the execution of the data pipeline. The system first prepares the necessary data sources by gathering, transforming, or staging data for processing. Once the data sources are prepared, the system executes the root nodes of the pipeline, representing foundational tasks that subsequent nodes depend upon.

The system provides for the dynamic determination of whether the pipeline execution is asynchronous. If asynchronous execution is enabled, the system enters a state where it waits for status updates from the nodes, allowing the pipeline to continue processing in the background without impeding other operations. In cases where asynchronous execution is not enabled, the system proceeds synchronously, waiting for each node to complete its execution before advancing to the next step.

The system includes a node status-checking mechanism, whereby the system evaluates whether the node status is complete. If any node fails to complete, the system triggers a pipeline failure state, halting further execution and initiating error-handling protocols. If the node status is determined to be complete, the system proceeds to evaluate whether all nodes within the pipeline have successfully completed their execution.

If all nodes in the pipeline have completed successfully, the process is deemed a pipeline success, indicating that the system has executed all necessary steps without errors. If not all nodes are complete, the system proceeds to execute child nodes, which are dependent on the successful execution of the root or parent nodes.

To maintain proper execution order, the system waits for any parent nodes to complete before executing their associated child nodes. The system includes a dependency management feature that ensures child nodes are only executed after their respective parent nodes have completed successfully. Once the required conditions are met, the system executes the individual node. This system provides for pipeline execution management, offering the flexibility of asynchronous processing, real-time status monitoring, and dependency management within data pipelines.

In some implementations, the execution engine may support both synchronous and asynchronous operation modes on a per-process basis. In asynchronous mode, the engine advances the workflow upon receipt of status updates from nodes, whereas in synchronous mode it blocks until each node signals completion. Node status transitions can include at least: Created, Running, Complete, Failed, and Canceled. Failure of any required node triggers a pipeline failure state and emits a structured event for observability and remediation.

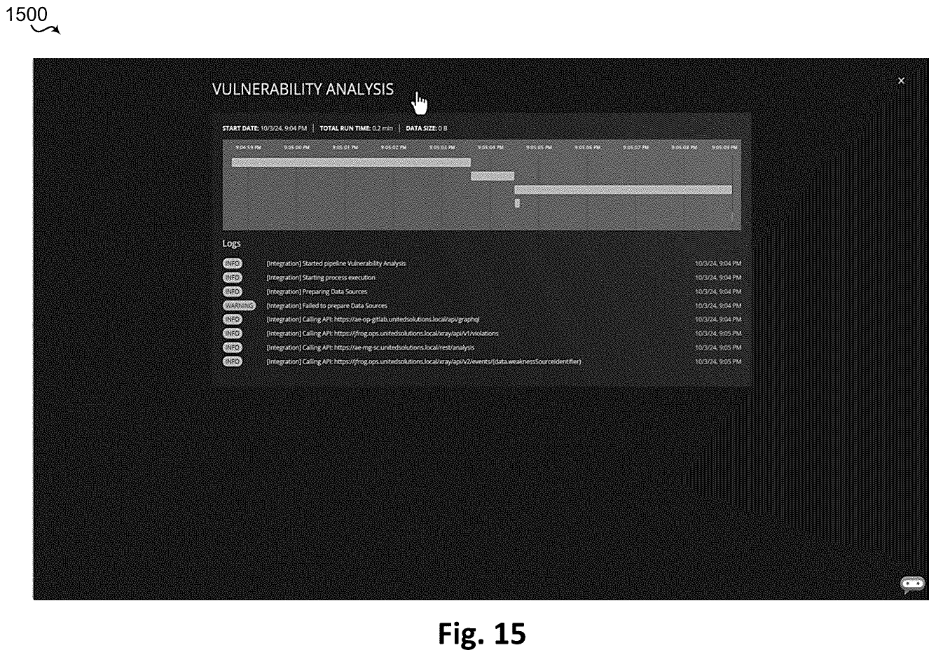

Referring to FIG. 15, a diagram 1500 of an interface for vulnerability analysis of a data pipeline in accordance with an example implementation is provided. For example, diagram 1500 illustrates monitoring and tracking the progress of vulnerability analysis processes through the use of a visual timeline and detailed logging framework. The system enables real-time monitoring of the steps executed during a vulnerability analysis, providing a mechanism for detecting, diagnosing, and resolving issues that arise during the analysis.

In one implementation, the system features a timeline interface that visually represents the execution of the vulnerability analysis from initiation to completion. The timeline is segmented into distinct phases or tasks, with each task having a duration block to indicate the start and end times of specific actions within the process. The system displays key parameters such as the start date, total run time, and data size processed during the analysis. These elements enable users to visually track the overall performance of the analysis and identify any delays or anomalies in task execution.

Additionally, the system includes a log monitoring framework that records detailed log entries for each step in the vulnerability analysis process. The logs contain timestamps and descriptive messages that document the actions performed, including the start of the pipeline, API calls made to external systems, and status updates for each phase of the analysis. The logs are augmented with visual indicators—such as error markers or success indicators—that allow users to quickly identify issues or failures in the analysis pipeline.

In the event of an error, such as a failed API call, the system automatically records the event with a red error indicator in the log interface, allowing for easy identification and follow-up action. Conversely, successful operations are marked with a blue indicator, providing transparency into the status of each completed task. The system further supports diagnostic capabilities by allowing users to trace each step of the process, ensuring that any failures or delays are fully auditable.

Further, in some aspects, the vulnerability analysis interface may present a timeline view of pipeline execution annotated with start time, run duration, and data size processed. Each pipeline step generates a corresponding log entry with a timestamp and severity. The interface distinguishes successful operations and error conditions with visual indicators and allows users to drill into failed steps to inspect the request and response context captured by the logging framework.

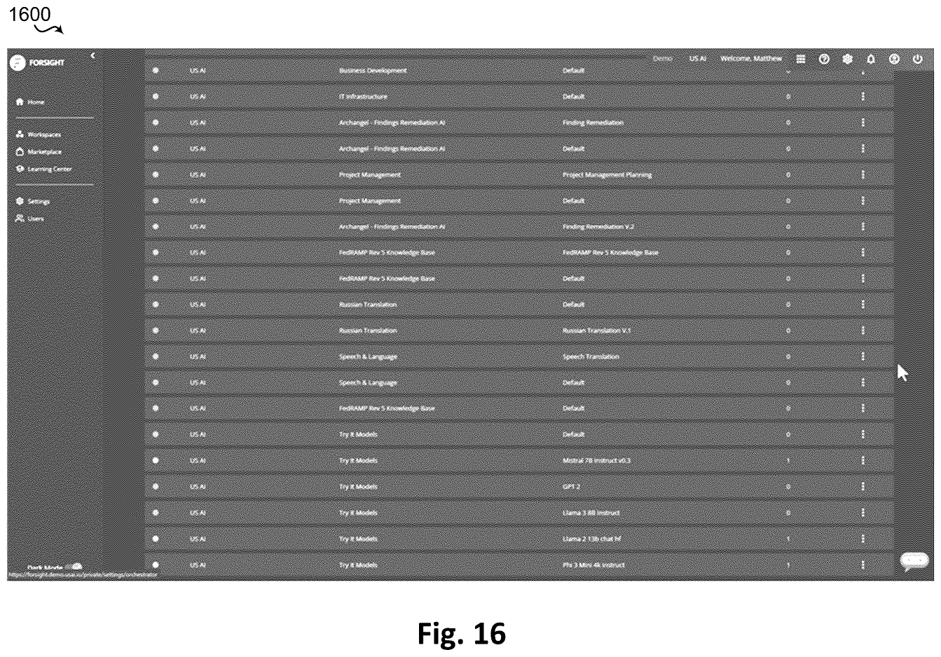

Referring to FIG. 16, a diagram 1600 of an interface for configuring graphics processing unit (GPU) clusters or pods in accordance with an example implementation is provided. For example, diagram 1600 illustrates dynamically provisioning and de-provisioning GPU clusters or pods to train and run AI inferences.

In an aspect, the system intelligently automates the management of cloud resources, enabling applications to dynamically configure and throttle GPU utilization. This system scales GPU usage in real-time, ensuring efficient allocation of resources based on the specific demands of the application. The system builds upon existing cloud infrastructure but operates above the hyperscaler's technology stack, a challenge that hyperscalers themselves have not addressed.

In one implementation, the system utilizes smart containers, orchestrated through Kubernetes, to dynamically start and stop containers based on the AI training or inference workload. Each container is uniquely linked to GPU resources through native API integrations with cloud hyperscalers. This allows the system to intelligently manage and distribute GPU resources across multiple cloud environments, ensuring optimal utilization. The system enables users and/or businesses to scale GPU clusters or pods dynamically, depending on the current processing needs, whether for training large-scale AI models or running inferences in real-time.

Furthermore, the system's capability to orchestrate cloud resources across all major cloud hyperscalers is a novel and non-obvious improvement over existing infrastructure. This enables users and/or businesses to operate in a multi-cloud environment, seamlessly leveraging GPU resources from various providers while ensuring the AI models are trained and executed efficiently.

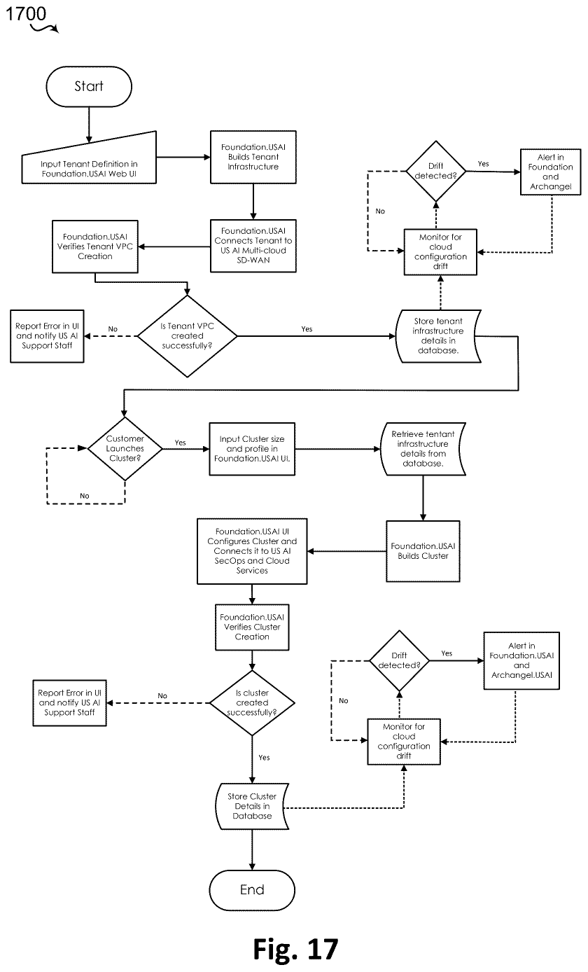

Referring to FIG. 17, a flowchart 1700 of an example of a method of automating enterprise cloud tenancy setup in accordance with an example implementation is provided. For example, flowchart 1700 illustrates automating and orchestrating enterprise cloud tenancy setup, enabling businesses to dynamically provision tenant infrastructure, configure cloud clusters, and manage cloud resources within a multi-cloud environment. The system integrates advanced Zero Trust architecture, DevSecOps, and infrastructure automation, ensuring secure and standardized management of cloud resources.

In one implementation, the invention provides a one-click solution for creating a dedicated cloud tenancy, enabling businesses to host their applications with the highest level of security standards. The system automates the provisioning of cloud tenancies by using Terraform scripts to install and configure security, database, and operational software on cloud infrastructure. These scripts are customized for different cloud hyperscalers and are designed to meet over 10,000 unique operational and security requirements, thereby ensuring compliance with stringent security frameworks, such as those required for Fed Civ and other high-level regulatory standards.

By automating this process, the system ensures that all applications hosted within a tenant environment are built and maintained to the same exacting security standards, regardless of funding or operational variations. The system's Zero Trust architecture and DevSecOps integration ensures that every tenant is built with inherent security, significantly reducing the risk of external and internal threats.

The system also incorporates infrastructure automation for tenant and cluster management. After the tenant infrastructure is provisioned, the system automates the creation of virtual private clouds (VPCs) and cloud clusters, ensuring that infrastructure is built, configured, and verified in real-time. The system checks for successful VPC and cluster creation, storing all configuration details in a database and continuously monitoring for cloud configuration drift to ensure that any unauthorized changes are detected and reported.

In addition to infrastructure automation, the system includes a Anomaly AI for cyber risk and fraud detection, leveraging unsupervised machine learning to analyze vast amounts of non-standardized data. The Anomaly AI uses machine learning algorithms to detect cyber vulnerabilities, fraud, waste and abuse, and other risks across federal and commercial systems. The system autonomously scrutinizes terabytes of data generated hourly and extracts the most useful anomalies. This provides users and/or businesses with actionable insights without the need for significant investment in monitoring technologies or extensive data scientist involvement.

Furthermore, the system incorporates both Classical AI and Generative AI (Gen AI) capabilities for both defensive and offensive cyber operations. Current AI applications are typically used for defensive measures, such as identifying vulnerabilities, detecting breaches, and responding to attacks. The system utilizes the ability to use AI for offensive cyber operations, learning from attacker behavior and orchestrating counter-attacks using an intelligent computing fabric. The system integrates application, data, and cloud planes to orchestrate a coordinated response to cyber threats, effectively transforming digital resources into a powerful digital weapon.

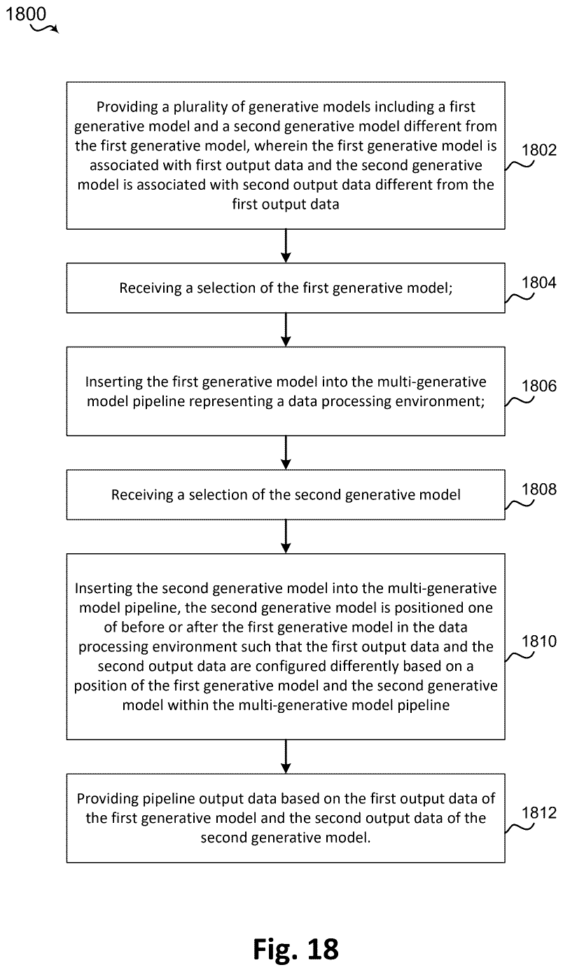

Referring to FIGS. 18-23, in operation, computing device 102 (FIG. 1) or 2400 (FIG. 24) may perform a method 1800 of constructing a multi-generative model pipeline, such as via execution of multi-generative AI component 115 by one or more processors 2404 of the processing unit 2402 configured, individually or in any combination, to execute instructions to perform the following actions, and/or configured to communicate with one or more memories 2408 of the system memory 2406 to obtain and execute the instructions.

At block 1802, the method 1800 includes providing a plurality of generative models including a first generative model and a second generative model different from the first generative model, the first generative model is associated with first output data and the second generative model is associated with second output data different from the first output data. For example, in an aspect, computing device 102/2400, one or more processors 2404, one or more memories 2408, multi-generative AI component 115, and/or providing component 2420 may be configured to or may comprise means for providing a plurality of generative models including a first generative model and a second generative model different from the first generative model, wherein the first generative model is associated with first output data and the second generative model is associated with second output data different from the first output data.

At block 1804, the method 1800 includes receiving a selection of the first generative model. For example, in an aspect, computing device 102/2400, one or more processors 2404, one or more memories 2408, multi-generative AI component 115, and/or providing component 2420 may be configured to or may comprise means for receiving a selection of the first generative model.

At block 1806, the method 1800 includes inserting the first generative model into the multi-generative model pipeline representing a data processing environment. For example, in an aspect, computing device 102/2400, one or more processors 2404, one or more memories 2408, multi-generative AI component 115, and/or providing component 2420 may be configured to or may comprise means for inserting the first generative model into the multi-generative model pipeline representing a data processing environment.

At block 1808, the method 1800 includes receiving a selection of the second generative model. For example, in an aspect, computing device 102/2400, one or more processors 2404, one or more memories 2408, multi-generative AI component 115, and/or providing component 2420 may be configured to or may comprise means for receiving a selection of the second generative model.

At block 1810, the method 1800 includes inserting the second generative model into the multi-generative model pipeline, where the second generative model is positioned one of before or after the first generative model in the data processing environment such that the first output data and the second output data are configured differently based on a position of the first generative model and the second generative model within the multi-generative model pipeline. For example, in an aspect, computing device 102/2400, one or more processors 2404, one or more memories 2408, multi-generative AI component 115, and/or providing component 2420 may be configured to or may comprise means for inserting the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline.

At block 1812, the method 1800 includes providing pipeline output data based on the first output data of the first generative model and the second output data of the second generative model. For example, in an aspect, computing device 102/2400, one or more processors 2404, one or more memories 2408, multi-generative AI component 115, and/or providing component 2420 may be configured to or may comprise means for providing pipeline output data based on the first output data of the first generative model and the second output data of the second generative model.

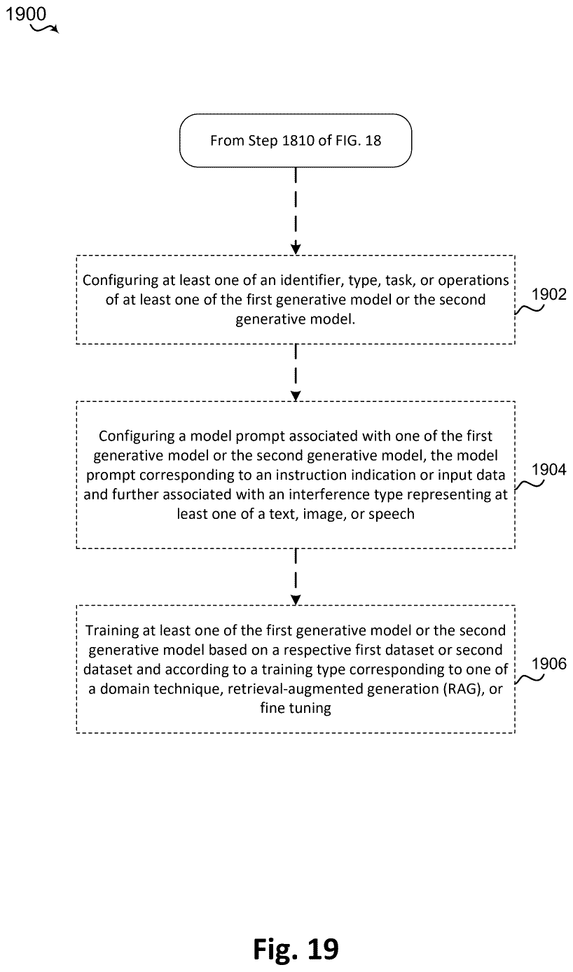

Referring to FIG. 19, in an alternative or additional aspect, at block 1902, the method 1900 may further include configuring at least one of an identifier, type, task, or operations of at least one of the first generative model or the second generative model. For example, in an aspect, computing device 102/2400, one or more processors 2404, one or more memories 2408, multi-generative AI component 115, and/or providing component 2420 may be configured to or may comprise means for configuring at least one of an identifier, type, task, or operations of at least one of the first generative model or the second generative model.

At block 1904, the 1900 may further include configuring a model prompt associated with one of the first generative model or the second generative model, the model prompt corresponding to an instruction indication or input data and further associated with an interference type representing at least one of a text, image, or speech. For example, in an aspect, computing device 102/2400, one or more processors 2404, one or more memories 2408, multi-generative AI component 115, and/or providing component 2420 may be configured to or may comprise means for configuring a model prompt associated with one of the first generative model or the second generative model, the model prompt corresponding to an instruction indication or input data and further associated with an interference type representing at least one of a text, image, or speech.

At block 1906, the method 1900 may further include training at least one of the first generative model or the second generative model based on a respective first dataset or second dataset and according to a training type corresponding to one of a domain technique, retrieval-augmented generation (RAG), or fine tuning. For example, in an aspect, computing device 102/2400, one or more processors 2404, one or more memories 2408, multi-generative AI component 115, and/or providing component 2420 may be configured to or may comprise means for training at least one of the first generative model or the second generative model based on a respective first dataset or second dataset and according to a training type corresponding to one of a domain technique, retrieval-augmented generation (RAG), or fine tuning.

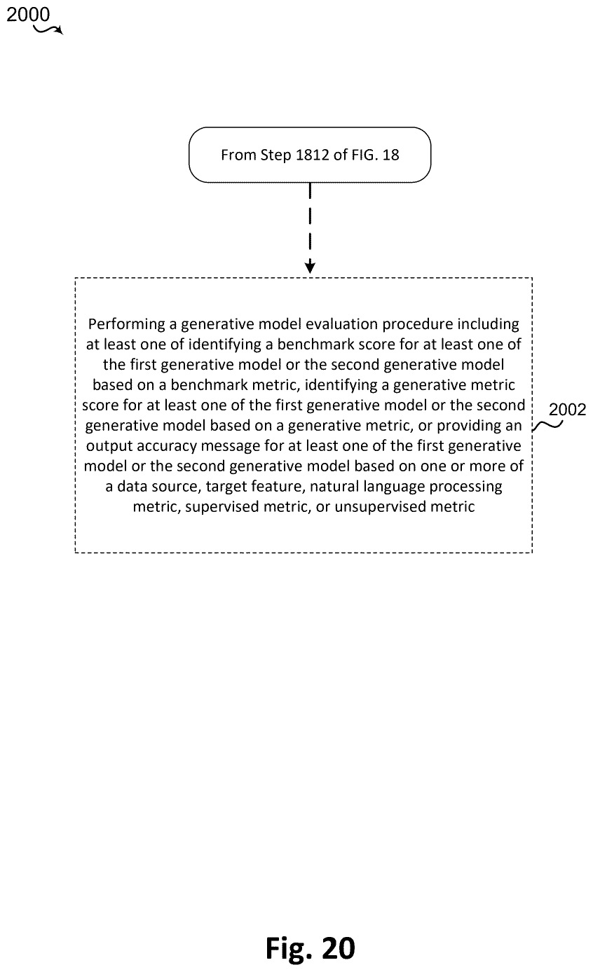

Referring to FIG. 20, in an alternative or additional aspect, at block 2002, the method 2000 may further include performing a generative model evaluation procedure including at least one of identifying a benchmark score for at least one of the first generative model or the second generative model based on a benchmark metric, identifying a generative metric score for at least one of the first generative model or the second generative model based on a generative metric, or providing an output accuracy message for at least one of the first generative model or the second generative model based on one or more of a data source, target feature, natural language processing metric, supervised metric, or unsupervised metric. For example, in an aspect, computing device 102/2400, one or more processors 2404, one or more memories 2408, multi-generative AI component 115, and/or providing component 2420 may be configured to or may comprise means for performing a generative model evaluation procedure including at least one of identifying a benchmark score for at least one of the first generative model or the second generative model based on a benchmark metric, identifying a generative metric score for at least one of the first generative model or the second generative model based on a generative metric, or providing an output accuracy message for at least one of the first generative model or the second generative model based on one or more of a data source, target feature, natural language processing metric, supervised metric, or unsupervised metric. In an alternative or additional aspect, a plurality of nodes representing distinct processes in the multi-generative model pipeline are linked based on a reference primary key identifier and a reference type to one or more of an application programming interface (API), a data model, or a questionnaire.

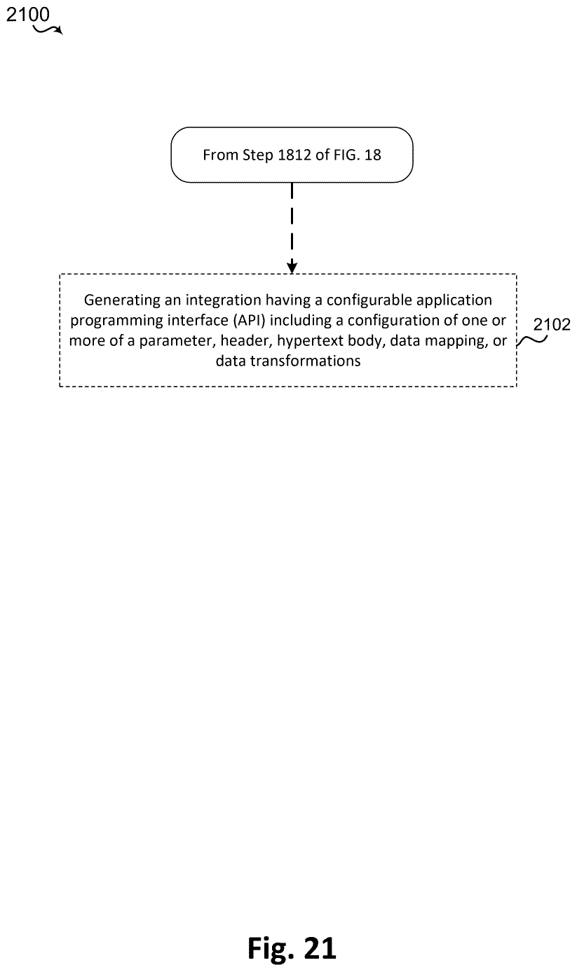

Referring to FIG. 21, in an alternative or additional aspect, at block 2102, the method 2100 may further include generating an integration having a configurable application programming interface (API) including a configuration of one or more of a parameter, header, hypertext body, data mapping, or data transformations. For example, in an aspect, computing device 102/2400, one or more processors 2404, one or more memories 2408, multi-generative AI component 115, and/or providing component 2420 may be configured to or may comprise means for generating an integration having a configurable application programming interface (API) including a configuration of one or more of a parameter, header, hypertext body, data mapping, or data transformations.

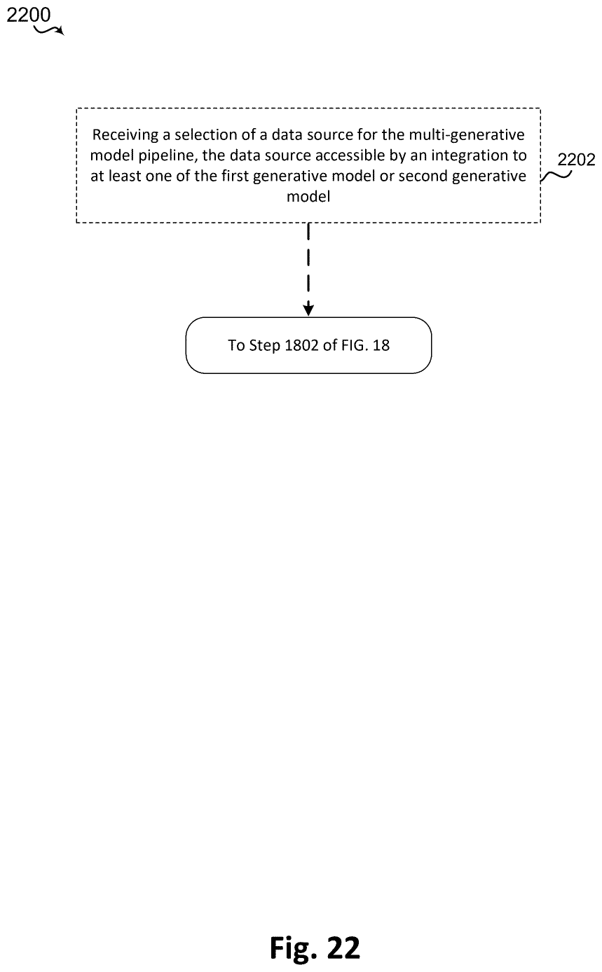

Referring to FIG. 22, in an alternative or additional aspect, at block 2202, the method 2200 may further include receiving a selection of a data source for the multi-generative model pipeline, the data source accessible by an integration to at least one of the first generative model or second generative model. For example, in an aspect, computing device 102/2400, one or more processors 2404, one or more memories 2408, multi-generative AI component 115, and/or providing component 2420 may be configured to or may comprise means for receiving a selection of a data source for the multi-generative model pipeline, the data source accessible by an integration to at least one of the first generative model or second generative model.

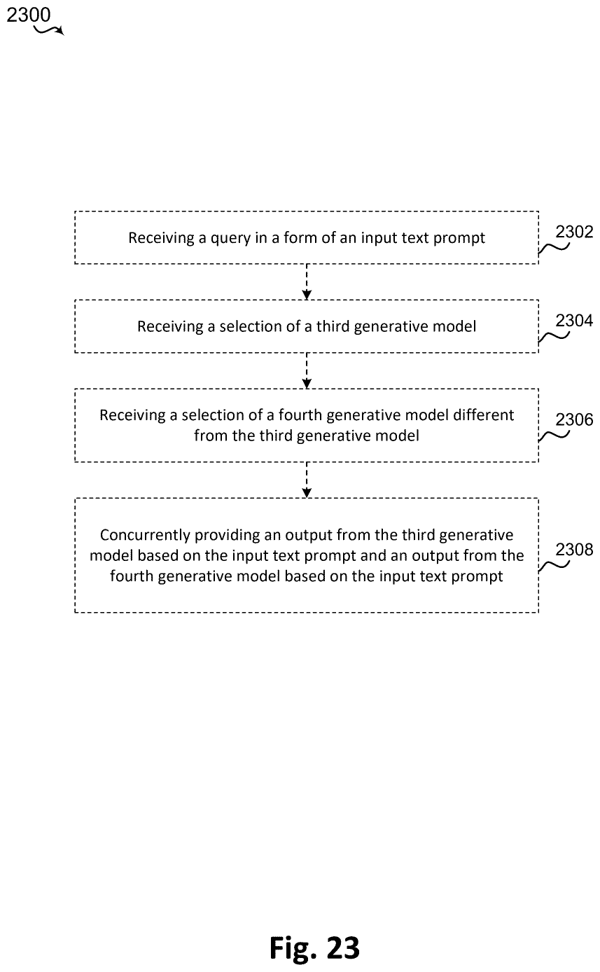

Referring to FIG. 23, in an alternative or additional aspect, at block 2302, the method 2300 may further include receiving a query in a form of an input text prompt. For example, in an aspect, computing device 102/2400, one or more processors 2404, one or more memories 2408, multi-generative AI component 115, and/or providing component 2420 may be configured to or may comprise means for receiving a query in a form of an input text prompt.

In this optional aspect, at block 2304, the method 2300 may further include receiving a selection of a third generative model. For example, in an aspect, computing device 102/2400, one or more processors 2404, one or more memories 2408, multi-generative AI component 115, and/or providing component 2420 may be configured to or may comprise means for receiving a selection of a third generative model.

In this optional aspect, at block 2306, the method 2300 may further include receiving a selection of a fourth generative model different from the third generative model. For example, in an aspect, computing device 102/2400, one or more processors 2404, one or more memories 2408, multi-generative AI component 115, and/or providing component 2420 may be configured to or may comprise means for receiving a selection of a fourth generative model different from the third generative model.

In this optional aspect, at block 2308, the method 2300 may further include concurrently providing an output from the third generative model based on the input text prompt and an output from the fourth generative model based on the input text prompt. For example, in an aspect, computing device 102/2400, one or more processors 2404, one or more memories 2408, multi-generative AI component 115, and/or providing component 2420 may be configured to or may comprise means for concurrently providing an output from the third generative model based on the input text prompt and an output from the fourth generative model based on the input text prompt.

In an alternative or additional aspect, the first generative model is associated with a first container having a first set of graphical processing unit (GPU) resources and the second generative model is associated with a second container having a second set of GPU resources different from the first set of GPU resources. FIG. 24 is a block diagram illustrating physical components (e.g., hardware) of a computing device 2400 with which examples of the present disclosure may be implemented. The computing device components described below may be suitable for one or more of the components of the system 100 described above. In a basic configuration, the computing device 2400 includes at least one processing unit 2402 including one or more processors 2404 and a system memory 2406. Based on the configuration and type of computing device 2400, the system memory 2406 may comprise volatile storage (e.g., random access memory), non-volatile storage (e.g., read-only memory), flash memory, or any combination of such memories for storing one or more program modules suitable for running software applications. The system memory 2406 may include an operating system 2408. The computing device 2400 may also include multi-generative AI component 115, which may be configured to build and configure generative AI models, chain generative AI models into a harmonious workflows, and manage cloud compute.

The operating system 2408 may be suitable for controlling the operation of the computing device 2400. Furthermore, aspects of the disclosure may be practiced in conjunction with a graphics library, other operating systems, or any other application program and is not limited to any particular application or system. The computing device 2400 may have additional features or functionality. For example, the computing device 2400 may also include additional data storage devices (removable and/or non-removable) such as, for example, magnetic disks, optical disks, or tape. Such additional storage is illustrated in FIG. 24 by a removable storage device 2460 and a non-removable storage device 2462.

In some aspects, a number of program modules and data files may be stored in the system memory 2406. While executing on the processing unit 2402, the multi-generative AI component 115 may perform processes including one or more of the stages of the methods 1800-2300 illustrated in FIGS. 18-23.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 24 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 2400 on the single integrated circuit (chip). Examples of the present disclosure may also be practiced using other technologies capable of performing logical operations such as, for example, AND, OR, and NOT, including mechanical, optical, fluidic, and quantum technologies.

The computing device 2400 may also have one or more input device(s) 2450 such as a keyboard, a mouse, a pen, a sound input device, a touch input device, a camera, etc. The output device(s) 2452 such as a display, speakers, a printer, etc. may also be included. The aforementioned devices are examples and others may be used. The computing device 2400 may include one or more communication connections allowing communications with other computing devices 2418. Examples of suitable communication connections include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 804, the removable storage device 809, and the non-removable storage device 810 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer readable media may be part of the computing device 800. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example implementations are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Implementation examples are described in the following numbered clauses:

Clause 1. An apparatus for constructing a multi-generative model pipeline, comprising:

one or more memories; and

one or more processors coupled with one or more memories and configured, individually or in combination, to:
provide a plurality of generative models including a first generative model and a second generative model different from the first generative model, wherein the first generative model is associated with first output data and the second generative model is associated with second output data different from the first output data;
receive a selection of the first generative model;
insert the first generative model into the multi-generative model pipeline representing a data processing environment;
receive a selection of the second generative model;
insert the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline; and
provide pipeline output data based on the first output data of the first generative model and the second output data of the second generative model.

Clause 2. The apparatus of clause 1, wherein the one or more processors are further configured to configure at least one of an identifier, type, task, or operations of at least one of the first generative model or the second generative model.

Clause 3. The apparatus of any of clauses 1 and 2, wherein the one or more processors are further configured to configure a model prompt associated with one of the first generative model or the second generative model, the model prompt corresponding to an instruction indication or input data and further associated with an interference type representing at least one of a text, image, or speech.

Clause 4. The apparatus of any of clauses 1-3, wherein the one or more processors are further configured to train at least one of the first generative model or the second generative model based on a respective first dataset or second dataset and according to a train type corresponding to one of a domain technique, retrieval-augmented generation (RAG), or fine tuning.

Clause 5. The apparatus of any of clauses 1-4, wherein the one or more processors are further configured to perform a generative model evaluation procedure including at least one of identifying a benchmark score for at least one of the first generative model or the second generative model based on a benchmark metric, identifying a generative metric score for at least one of the first generative model or the second generative model based on a generative metric, or to provide an output accuracy message for at least one of the first generative model or the second generative model based on one or more of a data source, target feature, natural language processing metric, supervised metric, or unsupervised metric.

Clause 6. The apparatus of any of clauses 1-5, wherein a plurality of nodes representing distinct processes in the multi-generative model pipeline are linked based on a reference primary key identifier and a reference type to one or more of an application programming interface (API), a data model, or a questionnaire.

Clause 7. The apparatus of any of clauses 1-6, wherein the one or more processors are further configured to generate an integration having a configurable application programming interface (API) including a configuration of one or more of a parameter, header, hypertext body, data mapping, or data transformations.

Clause 8. The apparatus of any of clauses 1-7, wherein the one or more processors are further configured to receive a selection of a data source for the multi-generative model pipeline, the data source accessible by an integration to at least one of the first generative model or second generative model.

Clause 9. The apparatus of any of clauses 1-8, wherein the one or more processors are further configured to:

receive a query in a form of an input text prompt;

receive a selection of a third generative model;

receive a selection of a fourth generative model different from the third generative model; and

concurrently provide an output from the third generative model based on the input text prompt and an output from the fourth generative model based on the input text prompt.

10. The apparatus of any of clauses 1-9, wherein the first generative model is associated with a first container having a first set of graphical processing unit (GPU) resources and the second generative model is associated with a second container having a second set of GPU resources different from the first set of GPU resources.

Clause 11: A method for constructing a multi-generative model pipeline, comprising steps for performing any one of clauses 1 to 10.

Clause 12: An apparatus, comprising means for performing a method in accordance with any one of clauses 1 to 10.

Clause 13: A non-transitory computer-readable medium comprising executable instructions that, when executed by one or more processors of an apparatus, cause the apparatus to perform a method in accordance with any one of clauses 1 to 10.The flowchart and block diagrams in the figures illustrate examples of the architecture, functionality, and operation of possible implementations of systems, methods, and computer program products according to various implementations. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or implementations may be described or claimed in the singular, the plural is contemplated unless limitation to the singular is explicitly stated. Additionally, all or a portion of any aspect and/or implementation may be utilized with all or a portion of any other aspect and/or implementation, unless stated otherwise.

What is claimed is:

1. An apparatus for constructing a multi-generative model pipeline, comprising:
one or more memories; and
one or more processors coupled with one or more memories and configured, individually or in combination, to:
provide a plurality of generative models including a first generative model and a second generative model different from the first generative model, wherein the first generative model is associated with first output data and the second generative model is associated with second output data different from the first output data;
receive a selection of the first generative model;
insert the first generative model into the multi-generative model pipeline representing a data processing environment;
receive a selection of the second generative model;
insert the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline; and
provide pipeline output data based on the first output data of the first generative model and the second output data of the second generative model.

2. The apparatus of claim 1, wherein the one or more processors are further configured to configure at least one of an identifier, type, task, or operations of at least one of the first generative model or the second generative model.

3. The apparatus of claim 1, wherein the one or more processors are further configured to configure a model prompt associated with one of the first generative model or the second generative model, the model prompt corresponding to an instruction indication or input data and further associated with an interference type representing at least one of a text, image, or speech.

4. The apparatus of claim 1, wherein the one or more processors are further configured to train at least one of the first generative model or the second generative model based on a respective first dataset or second dataset and according to a train type corresponding to one of a domain technique, retrieval-augmented generation (RAG), or fine tuning.

5. The apparatus of claim 1, wherein the one or more processors are further configured to perform a generative model evaluation procedure including at least one of identifying a benchmark score for at least one of the first generative model or the second generative model based on a benchmark metric, identifying a generative metric score for at least one of the first generative model or the second generative model based on a generative metric, or to provide an output accuracy message for at least one of the first generative model or the second generative model based on one or more of a data source, target feature, natural language processing metric, supervised metric, or unsupervised metric.

6. The apparatus of claim 1, wherein a plurality of nodes representing distinct processes in the multi-generative model pipeline are linked based on a reference primary key identifier and a reference type to one or more of an application programming interface (API), a data model, or a questionnaire.

7. The apparatus of claim 1, wherein the one or more processors are further configured to generate an integration having a configurable application programming interface (API) including a configuration of one or more of a parameter, header, hypertext body, data mapping, or data transformations.

8. The apparatus of claim 1, wherein the one or more processors are further configured to receive a selection of a data source for the multi-generative model pipeline, the data source accessible by an integration to at least one of the first generative model or second generative model.

9. The apparatus of claim 1, wherein the one or more processors are further configured to:
receive a query in a form of an input text prompt;
receive a selection of a third generative model;
receive a selection of a fourth generative model different from the third generative model; and
concurrently provide an output from the third generative model based on the input text prompt and an output from the fourth generative model based on the input text prompt.

10. The apparatus of claim 1, wherein the first generative model is associated with a first container having a first set of graphical processing unit (GPU) resources and the second generative model is associated with a second container having a second set of GPU resources different from the first set of GPU resources.

11. A method of constructing a multi-generative model pipeline, comprising:
providing a plurality of generative models including a first generative model and a second generative model different from the first generative model, wherein the first generative model is associated with first output data and the second generative model is associated with second output data different from the first output data;
receiving a selection of the first generative model;
inserting the first generative model into the multi-generative model pipeline representing a data processing environment;
receiving a selection of the second generative model;
inserting the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline; and
providing pipeline output data based on the first output data of the first generative model and the second output data of the second generative model.

12. The method of claim 11, further comprising configuring at least one of an identifier, type, task, or operations of at least one of the first generative model or the second generative model.

13. The method of claim 11, further comprising configuring a model prompt associated with one of the first generative model or the second generative model, the model prompt corresponding to an instruction indication or input data and further associated with an interference type representing at least one of a text, image, or speech.

14. The method of claim 11, further comprising training at least one of the first generative model or the second generative model based on a respective first dataset or second dataset and according to a training type corresponding to one of a domain technique, retrieval-augmented generation (RAG), or fine tuning.

15. The method of claim 11, further comprising performing a generative model evaluation procedure including at least one of identifying a benchmark score for at least one of the first generative model or the second generative model based on a benchmark metric, identifying a generative metric score for at least one of the first generative model or the second generative model based on a generative metric, or providing an output accuracy message for at least one of the first generative model or the second generative model based on one or more of a data source, target feature, natural language processing metric, supervised metric, or unsupervised metric.

16. The method of claim 11, wherein a plurality of nodes representing distinct processes in the multi-generative model pipeline are linked based on a reference primary key identifier and a reference type to one or more of an application programming interface (API), a data model, or a questionnaire.

17. The method of claim 11, further comprising generating an integration having a configurable application programming interface (API) including a configuration of one or more of a parameter, header, hypertext body, data mapping, or data transformations.

18. The method of claim 11, further comprising receiving a selection of a data source for the multi-generative model pipeline, the data source accessible by an integration to at least one of the first generative model or second generative model.

19. The method of claim 11, further comprising:
receiving a query in a form of an input text prompt;
receiving a selection of a third generative model;
receiving a selection of a fourth generative model different from the third generative model; and
concurrently providing an output from the third generative model based on the input text prompt and an output from the fourth generative model based on the input text prompt.

20. A computer-readable medium having instructions stored thereon for constructing a multi-generative model pipeline, wherein the instructions are executable by one or more processors, individually or in combination, to:
provide a plurality of generative models including a first generative model and a second generative model different from the first generative model, wherein the first generative model is associated with first output data and the second generative model is associated with second output data different from the first output data;
receive a selection of the first generative model;
insert the first generative model into the multi-generative model pipeline representing a data processing environment;
receive a selection of the second generative model;
insert the second generative model into the multi-generative model pipeline, wherein the second generative model is positioned one of before or after the first generative model in the data processing environment such that the first output data and the second output data are configured differently based on a position of the first generative model and the second generative model within the multi-generative model pipeline; and
provide pipeline output data based on the first output data of the first generative model and the second output data of the second generative model.
